(19) United States
(12) Patent Application Publication
(10) Pub. No.: US 2015/0140396 A1
(43) Pub. Date: May 21, 2015

(54) POWER STORAGE UNIT AND ELECTRONIC DEVICE

(71) Applicant: SEMICONDUCTOR ENERGY LABORATORY CO., LTD., Atsugi-shi (JP)

(72) Inventor: Shunpei YAMAZAKI, Tokyo (JP)

(21) Appl. No.: 14/526,992

(22) Filed: Oct. 29, 2014

(30) Foreign Application Priority Data
Nov. 15, 2013 (JP) 2013-236696

(51) Int. Cl. H01G 11/82; H01G 11/24; H01M 2/02; H01G 11/06

(52) U.S. Cl. CPC H01G 11/82; H01G 11/06; H01G 11/24; H01M 2/021
USPC 429/127; 361/502

(57) ABSTRACT

One or each of a positive electrode and a negative electrode is covered by a bag-like insulating material. When bending is performed, the bag-like insulating material and an active material slide against each other, whereby lithium deposited on a surface of the active material can be removed. A power storage unit or the like whose function such as charge and discharge capacity is unlikely to be degraded is provided.

### TECHNICAL FIELD

One embodiment of the present invention relates to a power storage unit and a manufacturing method thereof.

Note that one embodiment of the present invention is not limited to the above technical field. The technical field of one embodiment of the invention disclosed in this specification and the like relates to an object, a method, or a manufacturing method. In addition, one embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a memory device, a method for driving any of them, and a method for manufacturing any of them.

Note that in this specification, the power storage unit is a collective term describing units and devices having a power storage function. Also in this specification, the electrochemical device is a collective term describing devices that can function using a power storage unit, a conductive layer, a resistor, a capacitor, and the like.

### BACKGROUND ART

In recent years, a variety of power storage units, for example, secondary batteries such as lithium-ion secondary batteries, lithium-ion capacitors, and air batteries, have been actively developed. In particular, demand for lithium-ion secondary batteries with high output and high energy density has rapidly grown with the development of the semiconductor industry, for electronic devices, for example, portable information terminals such as mobile phones, smartphones, and laptop computers, portable music players, and digital cameras; medical equipment; next-generation clean energy vehicles such as hybrid electric vehicles (HEVs), electric vehicles (EVs), and plug-in hybrid electric vehicles (PHEVs); and the like. The lithium-ion secondary batteries are essential as rechargeable energy supply sources for today's information society.

The performance required for the lithium-ion batteries includes increased energy density, improved cycle characteristics, safe operation under a variety of environments, and longer-term reliability.

Also in recent years, flexible display devices have been proposed to be mounted on a curved surface or worn on the human body such as head. This has increased demand for flexible power storage units that can be attached to a curved surface.

An example of the lithium-ion battery includes at least a positive electrode, a negative electrode, and an electrolyte solution (Patent Document 1).

### REFERENCE

### Patent Document

[Patent Document 1] Japanese Published Patent Application No. 2012-009418

### DISCLOSURE OF INVENTION

With repetition of charge of a power storage unit including lithium, lithium is deposited on a negative electrode in some cases. Particularly when the deposited lithium has a needle-like shape, a short-circuit is likely to occur between the negative electrode and the positive electrode through the deposited lithium. The deposition of lithium causes degradation in function, such as charge and discharge capacity, of the power storage unit and causes damage to the power storage unit. In the worst case, the power storage unit may catch fire.

An object of one embodiment of the present invention is to provide a power storage unit or the like whose function such as charge and discharge capacity is unlikely to be degraded. Another object of one embodiment of the present invention is to provide a power storage unit or the like which is unlikely to be damaged. Another object of one embodiment of the present invention is to provide a power storage unit or the like in which a defect is unlikely to occur. Another object of one embodiment of the present invention is to provide a highly reliable power storage unit or the like. Another object of one embodiment of the present invention is to provide a novel power storage unit or the like. Note that the descriptions of these objects do not disturb the existence of other objects. In one embodiment of the present invention, there is no need to achieve all the objects. Other objects will be apparent from and can be derived from the description of the specification, the drawings, the claims, and the like.

One or each of a positive electrode and a negative electrode is covered by a bag-like insulating material (hereinafter also referred to as an “envelope”). When bending is performed, the envelope and an active material slide against each other, whereby lithium deposited on a surface of the active material can be removed.

One embodiment of the present invention is a power storage unit which includes a positive electrode and a negative electrode in an exterior body and in which at least a part of the negative electrode is covered by a bag-like insulating material.

Another embodiment of the present invention is a power storage unit which includes a positive electrode and a negative electrode in an exterior body and in which at least a part of the positive electrode is covered by a bag-like insulating material.

Another embodiment of the present invention is a power storage unit which includes a positive electrode and a negative electrode in an exterior body and in which at least a part of the positive electrode and at least a part of the negative electrode are each covered by a bag-like insulating material.

Another embodiment of the present invention is a power storage unit including an active material covered by a bag-like insulating material.

Another embodiment of the present invention is a power storage unit in which the number of the positive electrodes is two or more and in which the number of the negative electrodes is two or more.

The power storage unit of one embodiment of the present invention can change its form in the range of radius of curvature of 10 mm or more, preferably 30 mm or more. One film or two films are used as the exterior body of the power storage unit. In the case where the power storage unit has a layered structure, a battery has a cross-sectional structure surrounded by two curves of the film(s) of the exterior body when bent. The power storage unit which has flexibility comprises the positive electrode which has flexibility, the negative electrode which has flexibility, the exterior body which has flexibility, and the bag-like insulating material which has flexibility.

A description is given of the radius of curvature of a surface with reference to FIGS. 32A to 32C. In FIG. 32A, on a plane 1701 along which a curved surface 1700 is cut, part of a curve 1702, which is a form of the curved surface, is approximate to an arc of a circle, and the radius of the circle is referred to as a radius 1703 of curvature. The center of the circle is referred to as a center 1704 of curvature. FIG. 32B is a top view of the curved surface 1700. FIG. 32C is a cross-sectional view of the curved surface 1700 taken along the plane 1701. When a curved surface is cut along a plane, the radius of curvature of a curve, which is a form of the curved surface, depends on place along which the curved surface is cut. Here, the radius of curvature of a curved surface is defined as the radius of curvature of a curve, which is a cross-sectional form of the curved surface, on a plane along which the curved surface is cut such that the curve has the smallest radius of curvature.

In the case of bending a power storage unit in which a component 1805 including electrodes, an electrolyte solution, and the like is sandwiched between two films as exterior bodies, a radius 1802 of curvature of a film 1801 closer to a center 1800 of curvature of the power storage unit is smaller than a radius 1804 of curvature of a film 1803 farther from the center 1800 of curvature (FIG. 33A). When the power storage unit is curved and has an arc-shaped cross section, compressive stress is applied to a surface of the film on the side closer to the center 1800 of curvature and tensile stress is applied to a surface of the film on the side farther from the center 1800 of curvature (FIG. 33B). However, by forming a pattern including projections or depressions on surfaces of the exterior bodies, influence of a strain can be reduced to be acceptable even when the compressive stress and the tensile stress are applied. For this reason, the power storage unit can change its form such that the exterior body on the side closer to the center of curvature has a curvature radius greater than or equal to 10 mm, preferably greater than or equal to 30 mm.

Note that the cross-sectional shape of the power storage unit is not limited to a simple arc shape, and the cross section can be partially arc-shaped; for example, a shape illustrated in FIG. 33C, a wavy shape illustrated in FIG. 33D, and an S shape can be used. When the curved surface of the power storage unit has a shape with a plurality of centers of curvature, the power storage unit can change its form such that a curved surface with the smallest radius of curvature among radii of curvature with respect to the plurality of centers of curvature, which is a surface of the exterior body on the side closer to the center of curvature, has a curvature radius greater than or equal to 10 mm, preferably greater than or equal to 30 mm.

One embodiment of the present invention can be used for various power storage devices. Examples of the power storage devices include a battery, a primary battery, a secondary battery, a lithium-ion secondary battery, and a lithium ion air battery. In addition, a capacitor is given as another example of the power storage devices. For example, with a combination of the negative electrode of one embodiment of the present invention and an electric double layer positive electrode, a capacitor such as a lithium ion capacitor can be manufactured.

A power storage unit or the like whose function such as charge and discharge capacity is less likely to be degraded can be provided. A power storage unit or the like which is less likely to be damaged can be provided. A highly reliable power storage unit or the like can be provided. A novel power storage unit or the like can be provided.

Note that the description of these effects does not disturb the existence of other effects. One embodiment of the present invention does not necessarily achieve all the effects listed above. Other effects will be apparent from and can be derived from the description of the specification, the drawings, the claims, and the like.

### BRIEF DESCRIPTION OF DRAWINGS

FIG. 1 illustrates an example of a power storage unit.

FIGS. 2A and 2B illustrate cross-sectional structures of the power storage unit.

FIGS. 3A to 3D illustrate a manufacturing process of the power storage unit.

FIGS. 4A to 4D illustrate the manufacturing process of the power storage unit.

FIGS. 5A and 5B illustrate the manufacturing process of the power storage unit.

FIGS. 6A to 6C illustrate the manufacturing process of the power storage unit.

FIGS. 7A and 7B illustrate a manufacturing process of a power storage unit.

FIGS. 8A and 8B illustrate examples of an envelope.

FIGS. 9A to 9C illustrate an example of a negative electrode covered by an envelope.

FIGS. 10A and 10B illustrate cross-sectional structures of a power storage unit.

FIGS. 11A and 11B illustrate cross-sectional structures of a power storage unit.

FIGS. 12A and 12B illustrate cross-sectional structures of a power storage unit.

FIGS. 13A and 13B illustrate a manufacturing process of a power storage unit.

FIGS. 14A to 14G illustrate examples of an electronic device.

FIGS. 15A to 15C illustrate an example of an electronic device.

FIG. 16 illustrates examples of an electronic device.

FIGS. 17A and 17B illustrate examples of an electronic device.

FIGS. 18A to 18C illustrate an example of a power storage unit.

FIGS. 19A and 19B illustrate an example of a power storage unit.

FIGS. 20A and 20B illustrate an example of a power storage device.

FIGS. 21A1, 21A2, 21B1, and 21B2 illustrate examples of a power storage device.

FIGS. 22A and 22B illustrate examples of a power storage device.

FIGS. 23A and 23B illustrate examples of a power storage device.

FIG. 24 illustrates an example of a power storage unit.

FIGS. 25A to 25C illustrate a manufacturing process of a power storage unit.

FIGS. 26A and 26B illustrate examples of a power storage unit.

FIGS. 27A and 27B illustrate examples of a power storage unit.

FIGS. 28A and 28B illustrate examples of a power storage unit.

FIGS. 29A and 29B illustrate examples of a power storage unit.

FIGS. 30A and 30B illustrate cross sections of a power storage unit.

FIGS. 31A and 31B illustrate cross sections of a power storage unit.

FIGS. 32A to 32C illustrate a radius of curvature of a surface.

FIGS. 33A to 33D illustrate cross sections of a power storage unit.

### BEST MODE FOR CARRYING OUT THE INVENTION

Embodiments of the present invention will be described below in detail with reference to the drawings. Note that the present invention is not limited to the following description, and it is easily understood by those skilled in the art that modes and details disclosed herein can be modified in various ways. Further, the present invention is not construed as being limited to description of the embodiments.

Note that in each drawing referred to in this specification, the size of each component or the thickness of each layer might be exaggerated or a region might be omitted for clarity of the invention. Therefore, embodiments of the present invention are not limited to such a scale.

Note that ordinal numbers such as “first” and “second” in this specification and the like are used in order to avoid confusion among components and do not denote the priority or the order such as the order of steps or the stacking order. A term without an ordinal number in this specification and the like might be provided with an ordinal number in a claim in order to avoid confusion among components.

### Embodiment 1

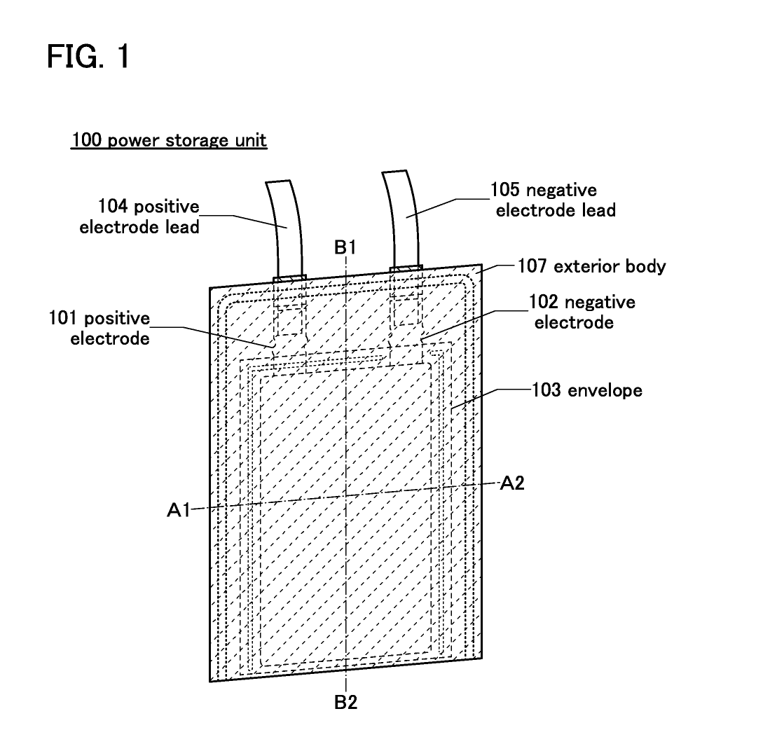

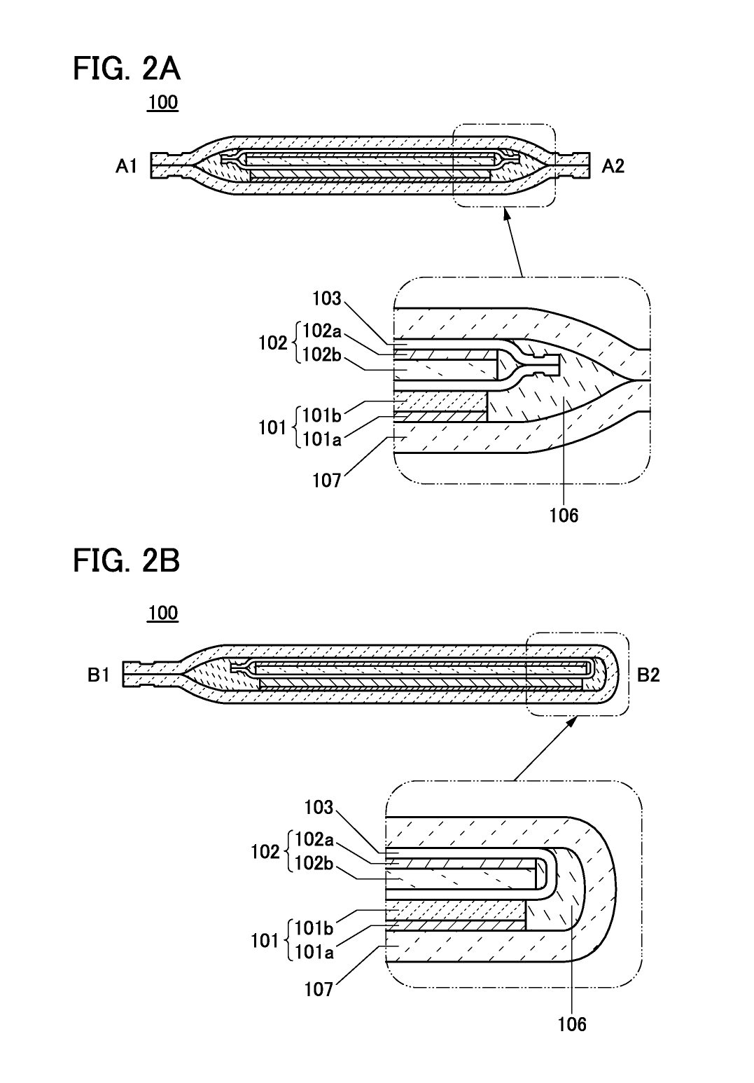

A structural example of a power storage unit 100 of one embodiment of the present invention is described with reference to drawings. FIG. 1 is a perspective view showing an appearance of the power storage unit 100. FIG. 2A is a cross-sectional view of a portion indicated by the dashed-dotted line A1-A2 in FIG. 1. FIG. 2B is a cross-sectional view of a portion indicated by the dashed-dotted line B1-B2 in FIG. 1.

The power storage unit 100 of one embodiment of the present invention includes, in an exterior body 107, a positive electrode 101, a negative electrode 102 covered by an envelope 103, and an electrolyte solution 106. In this embodiment, an example in which a pair of the positive electrode 101 and the negative electrode 102 is stored in the exterior body is given for simple description. However, a plurality of pairs of the positive electrode 101 and the negative electrode 102 may be stored in the exterior body in order to increase the capacity of the power storage unit. The positive electrode 101 is electrically connected to a positive electrode lead 104. The negative electrode 102 is electrically connected to a negative electrode lead 105. Each of the positive electrode lead 104 and the negative electrode lead 105 is also referred to as a lead electrode or a lead terminal. Parts of the positive electrode lead 104 and the negative electrode lead 105 are positioned outside the exterior body. The power storage unit 100 is charged and discharged through the positive electrode lead 104 and the negative electrode lead 105.

In FIGS. 2A and 2B, the negative electrode 102 is covered by the envelope 103. However, one embodiment of the present invention is not limited thereto. For example, the negative electrode 102 is not necessarily covered by the envelope 103; the positive electrode 101 may be covered by the envelope 103 instead of the negative electrode 102. The positive electrode 101 as well as the negative electrode 102 may also be covered by the envelope 103.

The power storage unit of one embodiment of the present invention can change its form in the range of radius of curvature of 10 mm or more, preferably 30 mm or more. One film or two films are used as the exterior body of the power storage unit. In the case where the power storage unit has a layered structure, a battery has a cross-sectional structure surrounded by two curves of the film(s) of the exterior body when bent.

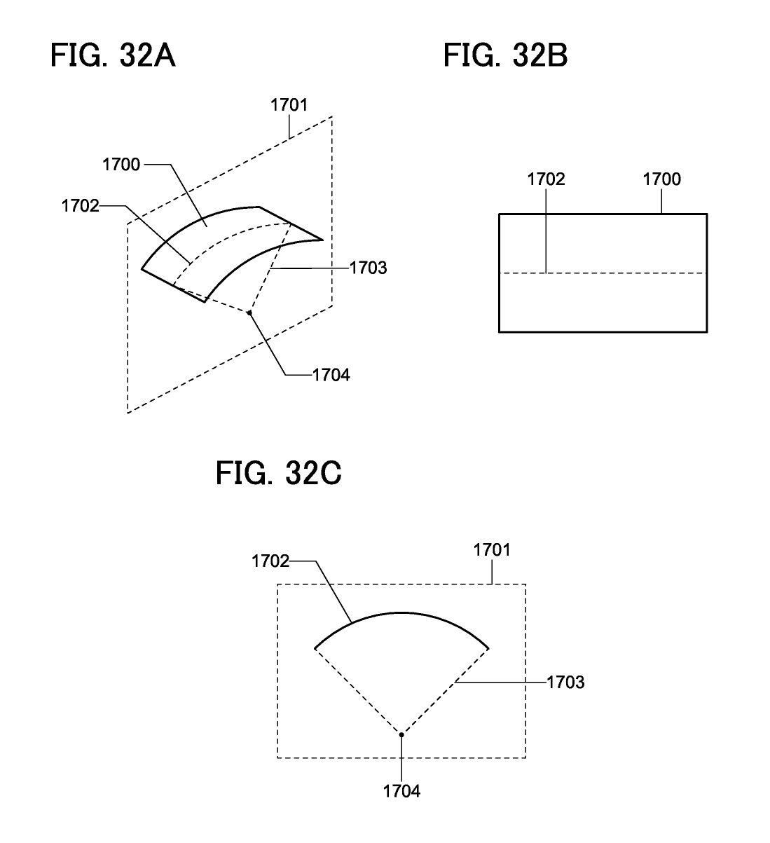

A description is given of the radius of curvature of a surface with reference to FIGS. 32A to 32C. In FIG. 32A, on a plane 1701 along which a curved surface 1700 is cut, part of a curve 1702, which is a form of the curved surface, is approximate to an arc of a circle, and the radius of the circle is referred to as a radius 1703 of curvature. The center of the circle is referred to as a center 1704 of curvature. FIG. 32B is a top view of the curved surface 1700. FIG. 32C is a cross-sectional view of the curved surface 1700 taken along the plane 1701. When a curved surface is cut along a plane, the radius of curvature of a curve, which is a form of the curved surface, depends on place along which the curved surface is cut. Here, the radius of curvature of a curved surface is defined as the radius of curvature of a curve, which is a cross-sectional form of the curved surface, on a plane along which the curved surface is cut such that the curve has the smallest radius of curvature.

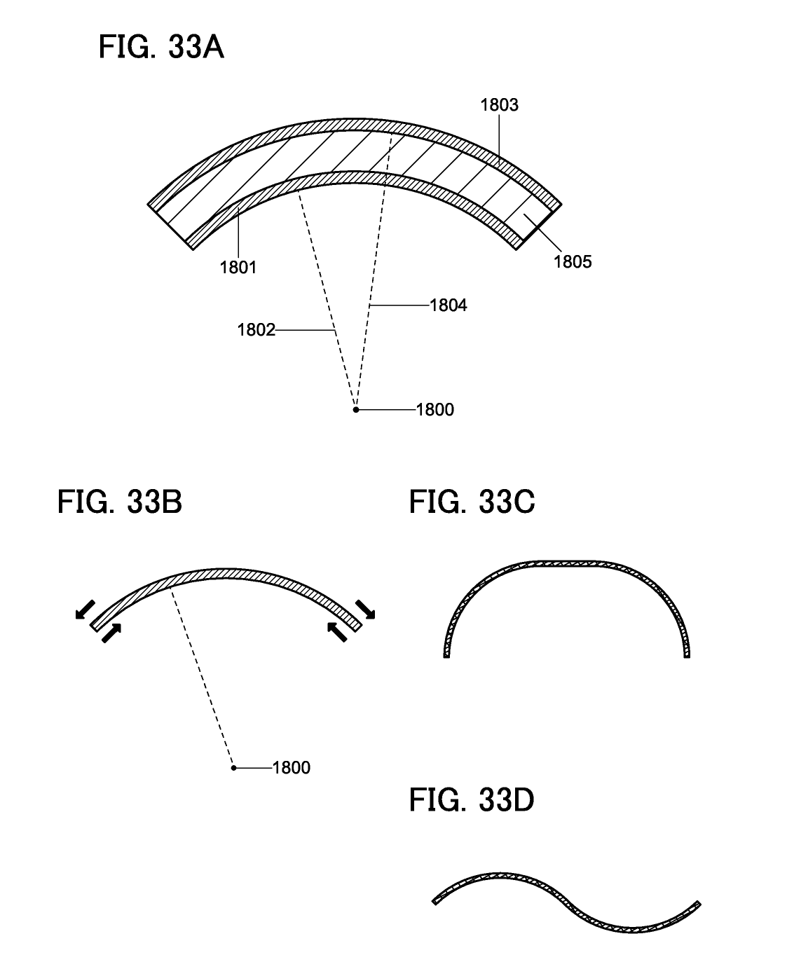

In the case of bending a power storage unit in which a component 1805 including electrodes, an electrolyte solution, and the like is sandwiched between two films as exterior bodies, a radius 1802 of curvature of a film 1801 closer to a center 1800 of curvature of the power storage unit is smaller than a radius 1804 of curvature of a film 1803 farther from the center 1800 of curvature (FIG. 33A). When the power storage unit is curved and has an arc-shaped cross section, compressive stress is applied to a surface of the film on the side closer to the center 1800 of curvature and tensile stress is applied to a surface of the film on the side farther from the center 1800 of curvature (FIG. 33B). However, by forming a pattern including projections or depressions on surfaces of the exterior bodies, influence of a strain can be reduced to be acceptable even when the compressive stress and the tensile stress are applied. For this reason, the power storage unit can change its form such that the exterior body on the side closer to the center of curvature has a curvature radius greater than or equal to 10 mm, preferably greater than or equal to 30 mm.

Note that the cross-sectional shape of the power storage unit is not limited to a simple arc shape, and the cross section can be partially arc-shaped; for example, a shape illustrated in FIG. 33C, a wavy shape illustrated in FIG. 33D, and an S shape can be used. When the curved surface of the power storage unit has a shape with a plurality of centers of curvature, the power storage unit can change its form such that a curved surface with the smallest radius of curvature among radii of curvature with respect to the plurality of centers of curvature, which is a surface of the exterior body on the side closer to the center of curvature, has a curvature radius greater than or equal to 10 mm, preferably greater than or equal to 30 mm.

### 1. POSITIVE ELECTRODE

The positive electrode 101 includes, for example, a positive electrode current collector 101a and a positive electrode active material layer 101b formed on the positive electrode current collector 101a. In this embodiment, an example of providing the positive electrode active material layer 101b on one surface of the positive electrode current collector 101a having a sheet shape (or a strip-like shape) is given. However, this embodiment is not limited thereto; the positive electrode active material layer 101b may be provided on both surfaces of the positive electrode current collector 101a. Providing the positive electrode active material layer 101b on both surfaces of the positive electrode current collector 101a allows the power storage unit 100 to have high capacity. Furthermore, in this embodiment, the positive electrode active material layer 101b is provided on the whole positive electrode current collector 101a. However, this embodiment is not limited thereto; the positive electrode active material layer 101b may be provided on a part of the positive electrode current collector 101a. For example, the positive electrode active material layer 101b is not provided on a portion of the positive electrode current collector 101a which is to be electrically in contact with the positive electrode lead 104 (hereinafter, the portion is also referred to as a “positive electrode tab”).

The positive electrode current collector 101a can be formed using a material that has high conductivity and is not alloyed with a carrier ion of lithium or the like, such as stainless steel, gold, platinum, zinc, iron, copper, aluminum, or titanium, an alloy thereof, or the like. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The positive electrode current collector 101a can have a foil-like shape, a plate-like shape (sheet-like shape), a net-like shape, a punching-metal shape, an expanded-metal shape, or the like as appropriate. The positive electrode current collector 101a preferably has a thickness greater than or equal to 5 μm and less than or equal to 30 μm. The surface of the positive electrode current collector 101a may be provided with an undercoat using graphite or the like.

The positive electrode active material layer 101b may further include a binder for increasing adhesion of positive electrode active materials, a conductive additive for increasing the conductivity of the positive electrode active material layer 101b, and the like in addition to the positive electrode active material.

Examples of a positive electrode active material used for the positive electrode active material layer 101b include a composite oxide with an olivine crystal structure, a composite oxide with a layered rock-salt crystal structure, and a composite oxide with a spinel crystal structure. As the positive electrode active material, a compound such as LiFeO₂, LiCoO₂, LiNiO₂, LiMn₂O₄, V₂O₅, Cr₂O₅, and MnO₂ is used.

LiCoO₂ is particularly preferable because it has high capacity, stability in the air higher than that of LiNiO₂, and thermal stability higher than that of LiNiO₂, for example.

It is preferable to add a small amount of lithium nickel oxide (LiNiO₂ or LiNi₁₋ₓMO₂ (M=Co, Al, or the like)) to a lithium-containing material with a spinel crystal structure which contains manganese such as LiMn₂O₄ because the elution of manganese and the decomposition of an electrolyte solution can be suppressed, for example.

Alternatively, a complex material (LiMPO₄ (general formula) (M is one or more of Fe(II), Mn(II), Co(II), and Ni(II))) can be used. Typical examples of the general formula LiMPO₄ are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

LiFePO₄ is particularly preferable because it properly satisfies conditions necessary for the positive electrode active material, such as safety, stability, high capacity density, high potential, and the existence of lithium ions which can be extracted in initial oxidation (charging).

Alternatively, a complex material such as Li(₂₋ⱼ)MSiO₄ (general formula) (M is one or more of Fe(II), Mn(II), Co(II), and Ni(II); 0≦j≦2) may be used. Typical examples of the general formula Li(₂₋ⱼ)MSiO₄ are lithium compounds such as Li(₂₋ⱼ)FeSiO₄, Li(₂₋ⱼ)CoSiO₄, Li(₂₋ⱼ)MnSiO₄, Li(₂₋ⱼ)FeₖNiₗSiO₄, Li(₂₋ⱼ)FeₖCoₗSiO₄, Li(₂₋ⱼ)FeₖMnₗSiO₄, Li(₂₋ⱼ)NiₖCoₗSiO₄, Li(₂₋ⱼ)NiₖMnₗSiO₄ (k+l≦1, 0<k<1, and 0<l<1), Li(₂₋ⱼ)FeₘNiₙCo_{q}SiO₄, Li(₂₋ⱼ)FeₘNiₙMn_{q}SiO₄, Li(₂₋ⱼ)NiₘCoₙMn_{q}SiO₄ (m+n+q≦1, 0<m<1, 0<n<1, and 0<q<1), and Li(₂₋ⱼ)FeᵣNiₛCoₜMnᵤSiO₄ (r+s+t+u≦1,0<r<1,0<s<1,0<t<1, and 0<u<1).

Still alternatively, a nasicon compound expressed by AₓM₂(XO₄)₃ (general formula) (A=Li, Na, or Mg, M=Fe, Mn, Ti, V, Nb, or Al, X═S, P, Mo, W, As, or Si) can be used as the positive electrode active material. Examples of the nasicon compound are Fe₂(MnO₄)₃, Fe₂(SO₄)₃, and Li₃Fe₂(PO₄)₃. Still further alternatively, compounds represented by a general formula, Li₂MPO₄F, Li₂MP₂O₇, and Li₅MO₄ (M=Fe or Mn), a perovskite fluoride such as NaFeF₃ and FeF₃, a metal chalcogenide (a sulfide, a selenide, and a telluride) such as TiS₂ and MoS₂, an oxide with an inverse spinel crystal structure such as LiMVO₄, a vanadium oxide (e.g., V₂O₅, V₆O₁₃, and LiV₃O₈), a manganese oxide, and an organic sulfur compound can be used as the positive electrode active material, for example.

In the case where carrier ions are alkali metal ions other than lithium ions or alkaline-earth metal ions, the positive electrode active material may contain, instead of lithium, an alkali metal (e.g., sodium or potassium) or an alkaline-earth metal (e.g., calcium, strontium, barium, beryllium, or magnesium). For example, the positive electrode active material may be a layered oxide containing sodium such as NaFeO₂ or Na_{2/3}[Fe_{1/2}Mn_{1/2}]O₂.

Further alternatively, any of the aforementioned materials may be combined to be used as the positive electrode active material. For example, the positive electrode active material may be a solid solution containing any of the aforementioned materials, e.g., a solid solution containing LiCo_{1/3}Mn_{1/3}Ni_{1/3}O₂ and Li₂MnO₃.

Note that although not shown, a conductive material such as a carbon layer may be provided on a surface of the positive electrode active material layer 101b. With the conductive material such as the carbon layer, conductivity of the electrode can be increased. For example, the positive electrode active material layer 101b can be coated with the carbon layer by mixing a carbohydrate such as glucose at the time of baking the positive electrode active material.

The average particle diameter of the primary particle of the positive electrode active material layer 101b is preferably greater than or equal to 50 nm and less than or equal to 100 μm.

Examples of the conductive additive include acetylene black (AB), graphite (black lead) particles, carbon nanotubes, graphene, and fullerene.

A network for electron conduction can be formed in the positive electrode 101 by the conductive additive. The conductive additive also allows maintaining of a path for electric conduction between the particles of the positive electrode active material layer 101b. The addition of the conductive additive to the positive electrode active material layer 101b increases the electron conductivity of the positive electrode active material layer 101b.

As the binder, instead of polyvinylidene fluoride (PVDF) as a typical one, polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, nitrocellulose or the like can be used.

The content of the binder in the positive electrode active material layer 101b is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %. The content of the conductive additive in the positive electrode active material layer 101b is preferably greater than or equal to 1 wt % and less than or equal to 10 wt %, more preferably greater than or equal to 1 wt % and less than or equal to 5 wt %.

In the case where the positive electrode active material layer 101b is formed by a coating method, the positive electrode active material, the binder, and the conductive additive are mixed to form a positive electrode paste (slurry), and the positive electrode paste is applied to the positive electrode current collector 101a and dried.

### 2. NEGATIVE ELECTRODE

The negative electrode 102 includes, for example, a negative electrode current collector 102a and a negative electrode active material layer 102b formed on the negative electrode current collector 102a. In this embodiment, an example of providing the negative electrode active material layer 102b on one surface of the negative electrode current collector 102a having a sheet shape (or a strip-like shape) is given. However, this embodiment is not limited thereto; the negative electrode active material layer 102b may be provided on both surfaces of the negative electrode current collector 102a. Providing the negative electrode active material layer 102b on both surfaces of the negative electrode current collector 102a allows the power storage unit 100 to have high capacity. Furthermore, in this embodiment, the negative electrode active material layer 102b is provided on the whole negative electrode current collector 102a. However, this embodiment is not limited thereto; the negative electrode active material layer 102b may be provided on a part of the negative electrode current collector 102a. For example, the negative electrode active material layer 102b is not provided on a portion of the negative electrode current collector 102a which is to be electrically in contact with the negative electrode lead 105 (hereinafter, the portion is also referred to as a “negative electrode tab”).

The negative electrode current collector 102a can be formed using a material that has high conductivity and is not alloyed with a carrier ion of lithium or the like, such as stainless steel, gold, platinum, zinc, iron, copper, titanium, or tantalum, an alloy thereof, or the like. Alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The negative electrode current collector 102a can have a foil-like shape, a plate-like shape (sheet-like shape), a net-like shape, a punching-metal shape, an expanded-metal shape, or the like as appropriate. The negative electrode current collector 102a preferably has a thickness greater than or equal to 5 μm and less than or equal to 30 μm. The surface of the negative electrode current collector 102a may be provided with an undercoat using graphite or the like.

The negative electrode active material layer 102b may further include a binder for increasing adhesion of negative electrode active materials, a conductive additive for increasing the conductivity of the negative electrode active material layer 102b, and the like in addition to the negative electrode active materials.

There is no particular limitation on the material of the negative electrode active material layer 102b as long as it is a material with which lithium can be dissolved and deposited or a material into/from which lithium ions can be inserted and extracted. Other than a lithium metal or lithium titanate, a carbon-based material generally used in the field of power storage, or an alloy-based material can also be used as the negative electrode active material layer 102b.

The lithium metal is preferable because of its low redox potential (3.045 V lower than that of a standard hydrogen electrode) and high specific capacity per unit weight and per unit volume (3860 mAh/g and 2062 mAh/cm³).

Examples of the carbon-based material include graphite, graphitizing carbon (soft carbon), non-graphitizing carbon (hard carbon), a carbon nanotube, graphene, carbon black, and the like.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (0.1 V to 0.3 V vs. Li/Li⁺) when lithium ions are inserted into the graphite (when a lithium-graphite intercalation compound is formed). For this reason, a lithium ion battery can have a high operating voltage. In addition, graphite is preferable because of its advantages such as relatively high capacity per unit volume, small volume expansion, low cost, and safety greater than that of a lithium metal.

For the negative electrode active material, an alloy-based material or oxide which enables charge-discharge reaction by an alloying reaction and a dealloying reaction with lithium can be used. In the case where lithium ions are carrier ions, the alloy-based material is, for example, a material containing at least one of Al, Si, Ge, Sn, Pb, Sb, Bi, Ag, Zn, Cd, In, Ga, and the like. Such elements have higher capacity than carbon. In particular, silicon has a theoretical capacity of 4200 mAh/g, which is significantly high. For this reason, silicon is preferably used as the negative electrode active material. Examples of the alloy-based material using such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, as the negative electrode active material layer 102b, oxide such as SiO, SnO, SnO₂, titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), molybdenum oxide (MoO₂), or the like can be used.

Still alternatively, as the negative electrode active material layer 102b, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material which does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Still further alternatively, as the negative electrode active material layer 102b, a material which causes conversion reaction can be used. For example, a transition metal oxide with which an alloying reaction with lithium is not caused, such as cobalt oxide (CoO), nickel oxide (NiO), or iron oxide (FeO), may be used for the negative electrode active material. Other examples of the material which causes a conversion reaction include oxides such as Fe₂O₃, CuO, Cu₂O, RuO₂, and Cr₂O₃, sulfides such as CoS_{0.89}, NiS, or CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as the negative electrode active material layer 102b because of its high potential.

In the case where the negative electrode active material layer 102b is formed by a coating method, the negative electrode active material and the binder are mixed to form a negative electrode paste (slurry), and the negative electrode paste is applied to the negative electrode current collector 102a and dried. Note that a conductive additive may be added to the negative electrode paste.

Graphene may be formed on a surface of the negative electrode active material layer 102b. For example, in the case of using silicon as the negative electrode active material layer 102b, the volume of silicon is greatly changed due to occlusion and release of carrier ions in charge-discharge cycles. Thus, adhesion between the negative electrode current collector 102a and the negative electrode active material layer 102b is decreased, resulting in degradation of battery characteristics caused by charge and discharge. In view of this, graphene is preferably formed on a surface of the negative electrode active material layer 102b containing silicon because even when the volume of silicon is changed in charge-discharge cycles, separation between the negative electrode current collector 102a and the negative electrode active material layer 102b can be prevented, which makes it possible to reduce degradation of battery characteristics.

Further, a coating film of oxide or the like may be formed on the surface of the negative electrode active material layer 102b. A coating film formed by decomposition or the like of an electrolyte solution or the like in charging cannot release electric charges used at the formation, and therefore forms irreversible capacity. In contrast, the film of an oxide or the like provided on the surface of the negative electrode active material layer 102b in advance can reduce or prevent generation of irreversible capacity.

As the coating film coating the negative electrode active material layer 102b, an oxide film of any one of niobium, titanium, vanadium, tantalum, tungsten, zirconium, molybdenum, hafnium, chromium, aluminum, and silicon or an oxide film containing any one of these elements and lithium can be used. Such a film is denser than a conventional film formed on a surface of a negative electrode due to a decomposition product of an electrolyte solution.

For example, niobium pentoxide (Nb₂O₅) has a low electric conductivity of 10⁻⁹ S/cm and a high insulating property. For this reason, a niobium oxide film inhibits electrochemical decomposition reaction between the negative electrode active material and the electrolyte solution. On the other hand, niobium oxide has a lithium diffusion coefficient of 10⁻⁹ cm²/sec and high lithium ion conductivity. Therefore, niobium oxide can transmit lithium ions. Alternatively, silicon oxide or aluminum oxide may be used.

A sol-gel method can be used to coat the negative electrode active material layer 102b with the coating film, for example. The sol-gel method is a method for forming a thin film in such a manner that a solution of metal alkoxide, a metal salt, or the like is changed into a gel, which has lost its fluidity, by hydrolysis reaction and polycondensation reaction and the gel is baked. Since a thin film is formed from a liquid phase in the sol-gel method, raw materials can be mixed uniformly on the molecular scale. For this reason, by adding a negative electrode active material such as graphite to a raw material of the metal oxide film which is a solvent, the active material can be easily dispersed into the gel. In such a manner, the coating film can be formed on the surface of the negative electrode active material layer 102b. A decrease in the capacity of the power storage unit can be prevented by using the coating film.

### 3. ENVELOPE

As a material of the envelope 103, a porous insulator such as cellulose, polypropylene (PP), polyethylene (PE), polybutene, nylon, polyester, polysulfone, polyacrylonitrile, polyvinylidene fluoride, or tetrafluoroethylene can be used. Alternatively, nonwoven fabric of a glass fiber or the like, or a diaphragm in which a glass fiber and a polymer fiber are mixed may be used.

With repetition of charge of a power storage unit including lithium, lithium is deposited on a negative electrode in some cases. Particularly in the case where the deposited lithium has a needle-like shape, a short-circuit is likely to occur between the negative electrode and the positive electrode through the deposited lithium. When the negative electrode 102 is covered by the envelope 103, bending of the power storage unit 100 allows a surface of the negative electrode active material layer 102b and the envelope 103 to slide against each other, whereby lithium deposited on the surface of the negative electrode active material layer 102b can be removed. This can prevent occurrence of a short circuit between the positive electrode 101 and the negative electrode 102 and accordingly prevent a function of the power storage unit 100 from being degraded. Furthermore, reliability of the power storage unit 100 can be increased. Particularly in the case where the negative electrode active material layer 102b is provided on both surfaces of the negative electrode current collector 102a, lithium deposited on the surfaces of the negative electrode active material layer 102b can be removed at the same time by bending the power storage unit 100. When the power storage unit 100 is bent intentionally, the above-described effect can be further increased.

Note that the case where the negative electrode 102 is covered by the envelope 103 is described here; however, one embodiment of the present invention is not limited thereto. For example, the negative electrode 102 is not necessarily covered by the envelope 103; the positive electrode 101 may be covered by the envelope 103 instead of the negative electrode 102. The positive electrode 101 as well as the negative electrode 102 may also be covered by the envelope 103, for example.

### 4. ELECTROLYTE SOLUTION

As a solvent of the electrolyte solution 106 used for the power storage unit 100, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

When a gelled high-molecular material is used as the solvent for the electrolyte solution, safety against liquid leakage and the like is improved. Further, a secondary battery can be thinner and more lightweight. Typical examples of the gelled high-molecular material include a silicone gel, an acrylic gel, an acrylonitrile gel, polyethylene oxide, polypropylene oxide, a fluorine-based polymer, and the like.

Alternatively, the use of one or more ionic liquids (room temperature molten salts) which are less likely to burn and volatilize as the solvent of the electrolyte solution can prevent the power storage unit from exploding or catching fire even when the power storage unit internally shorts out or the internal temperature increases due to overcharging or the like.

In the case of using a lithium ion as a carrier ion, as an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

The electrolyte solution used for the power storage unit preferably contains a small amount of dust particles and elements other than the constituent elements of the electrolyte solution (hereinafter, also simply referred to as impurities) so as to be highly purified. Specifically, the weight ratio of impurities to the electrolyte solution is less than or equal to 1%, preferably less than or equal to 0.1%, and more preferably less than or equal to 0.01%. An additive agent such as vinylene carbonate may be added to the electrolyte solution.

### 5. EXTERIOR BODY

The secondary battery can have any of a variety of structures. In this embodiment, a film is used for the exterior body 107. Note that the film used for the exterior body 107 is a single-layer film selected from a metal film (e.g., an aluminum film, a stainless steel film, and a nickel steel film), a plastic film made of an organic material, a hybrid material film including an organic material (e.g., an organic resin or fiber) and an inorganic material (e.g., ceramic), and a carbon-containing film (e.g., a carbon film or a graphite film); or a stacked-layer film including two or more of the above films. A metal film is easily embossed. Forming a depression or a projection on a surface of a metal film by embossing increases the surface area of the exterior body 107 exposed to outside air, achieving efficient heat dissipations.

In the case where the power storage unit 100 is changed in form by externally applying force, bending stress is externally applied to the exterior body 107 of the power storage unit 100. This might partly deform or damage the exterior body 107. The depression or projection formed on the surface of the exterior body 107 can relieve a strain caused by stress applied to the exterior body 107. Therefore, the power storage unit 100 can have high reliability. Note that a “strain” is the scale of change in form indicating the displacement of a point of an object relative to the reference (initial) length of the object. The depression or the projection formed on the surface of the exterior body 107 can reduce the influence of a strain caused by application of external force to the power storage unit to an acceptable level. Thus, the power storage unit having high reliability can be provided.

This embodiment can be implemented in appropriate combination with any of the other embodiments.

### Embodiment 2

In this embodiment, an example of a manufacturing method of the power storage unit 100 is described with reference to drawings.

### 1. COVERING NEGATIVE ELECTRODE BY ENVELOPE

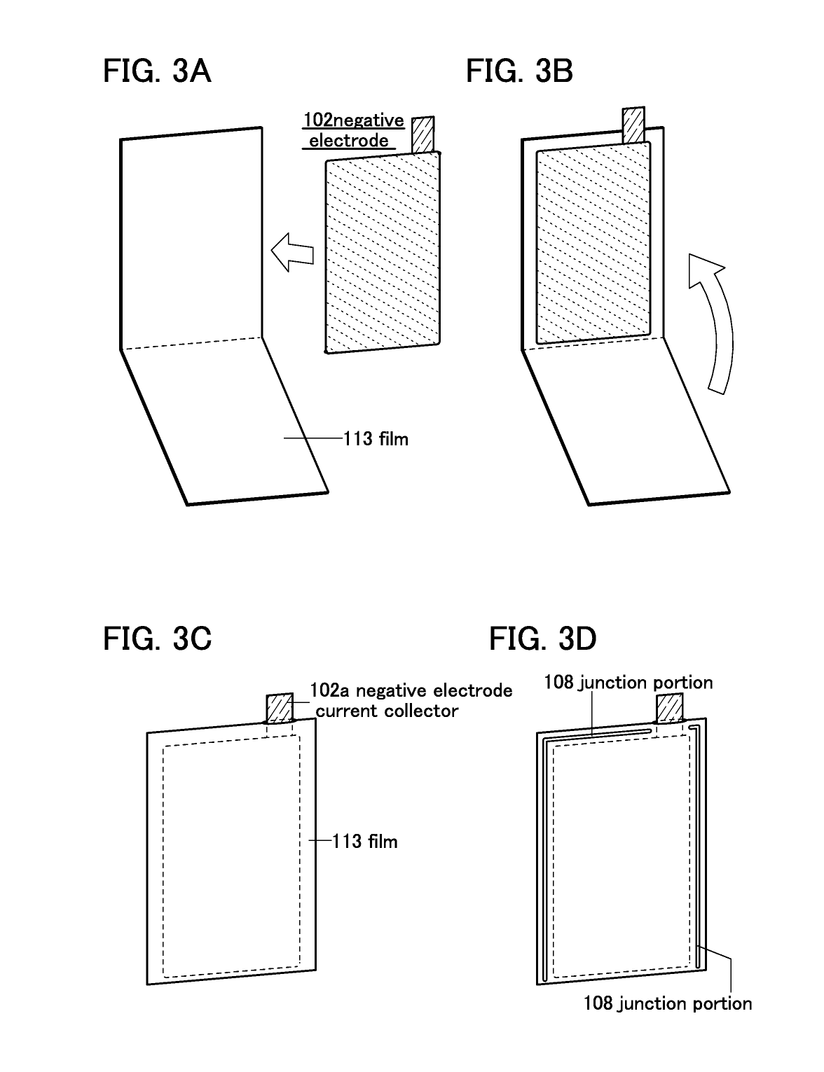

First, the negative electrode 102 is provided over a film 113 for forming the envelope 103 (see FIG. 3A). Then, the film 113 is folded along a portion indicated by a dotted line shown in FIG. 3A (see FIG. 3B), and the negative electrode 102 is interposed between one part of the film 113 and the other part thereof (see FIG. 3C).

Then, bonding is performed on the outer edges of the film 113 in the outside of the negative electrode 102 to form the envelope 103. The outer edges of the film 113 may be bonded to each other using an adhesive or the like or may be bonded by ultrasonic welding or thermal fusion bonding.

In this embodiment, polypropylene is used as the film 113, and the outer edges of the film 113 are bonded to each other by heating. A bonding portion 108 is shown in FIG. 3D. Thus, the negative electrode 102 can be covered by the envelope 103. The envelope 103 is formed so as to cover the negative electrode active material layer 102b and does not necessarily cover the whole negative electrode 102.

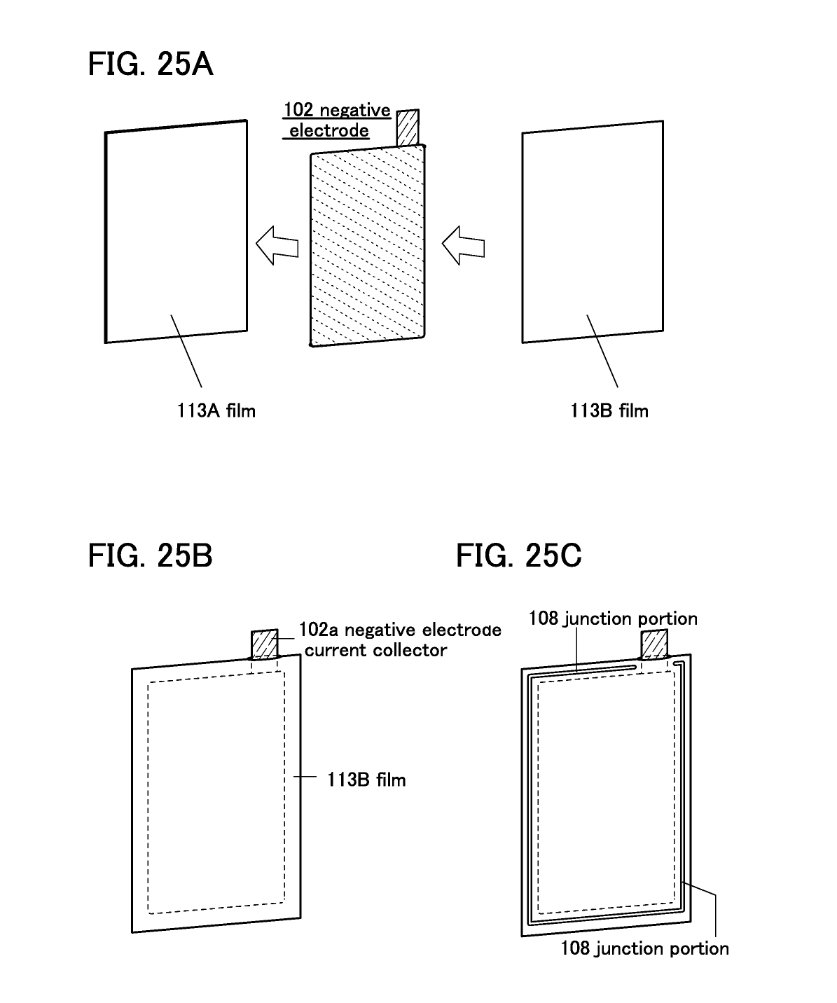

Note that although the film 113 is folded in FIGS. 3A to 3D, one embodiment of the present invention is not limited thereto. For example, the negative electrode 102 may be interposed between a film 113A and a film 113B as shown in FIGS. 25A to 25C. In that case, four sides of the negative electrode 102 may be almost surrounded by the bonding portion 108 as shown in FIG. 25C.

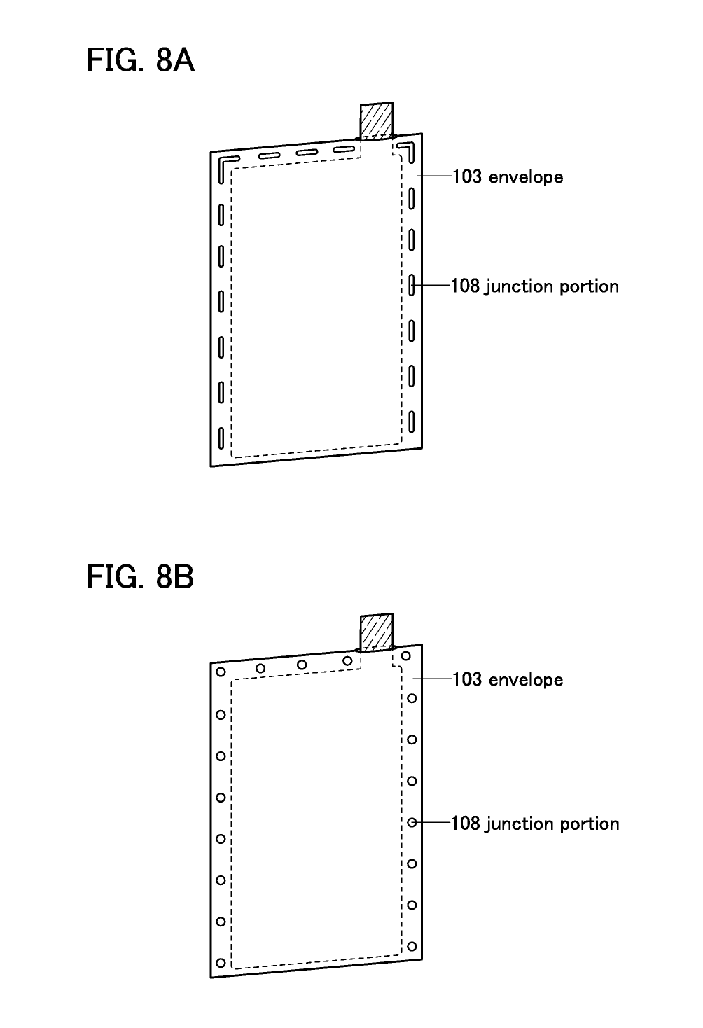

The outer edges of the film 113 may be bonded intermittently as shown in FIG. 8A or may be bonded at spots which are regularly spaced as shown in FIG. 8B.

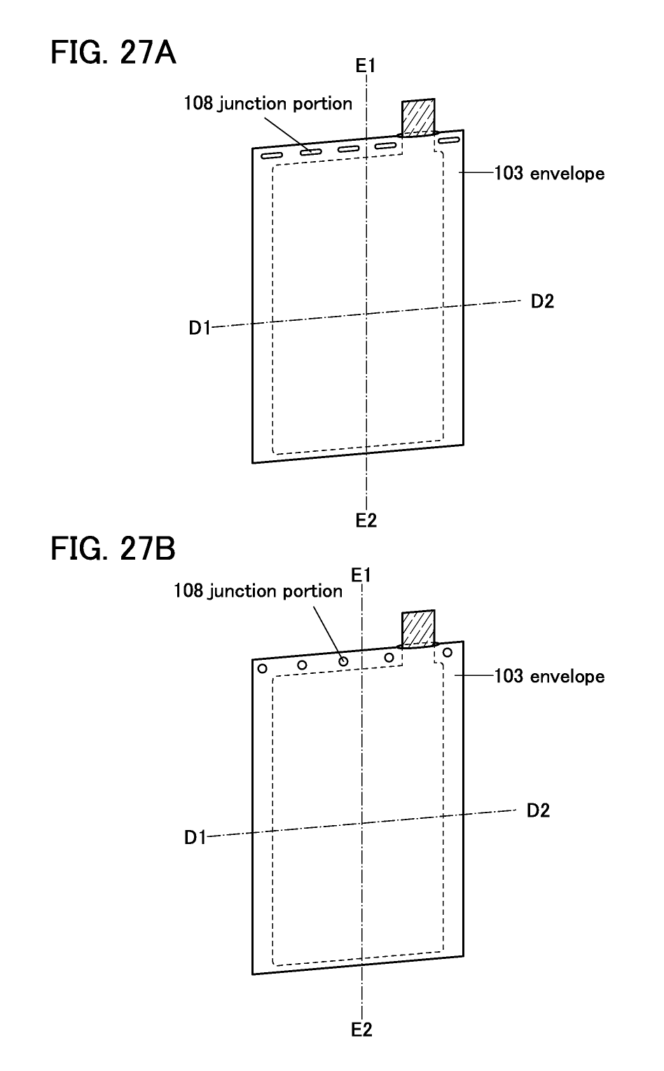

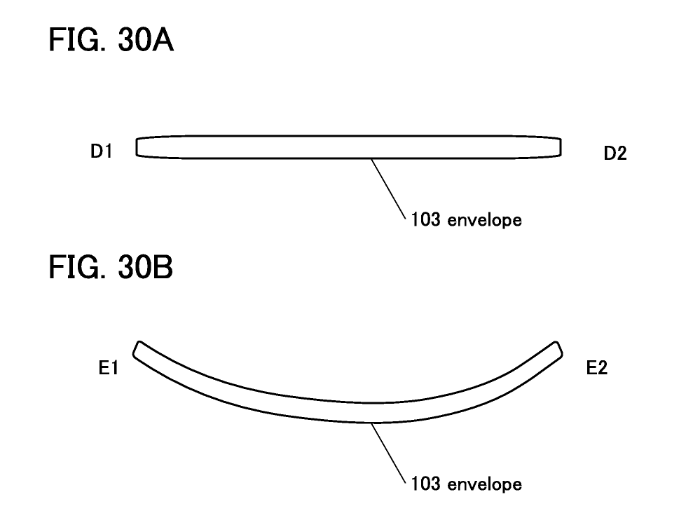

Alternatively, the bonding portion 108 may be provided in only one side of the envelope 103 as shown in FIGS. 27A and 27B. In this case, the bonding portion 108 can prevent the negative electrode 102 from being shifted too much when the power storage unit 100 or the envelope 103 is bent as in FIGS. 30A and 30B.

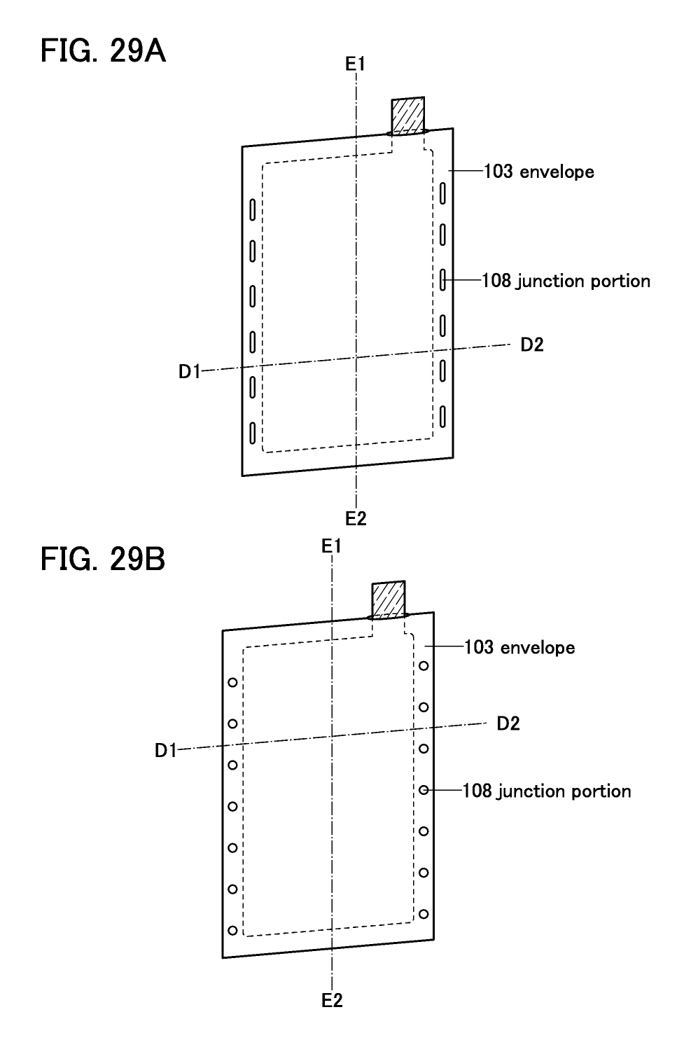

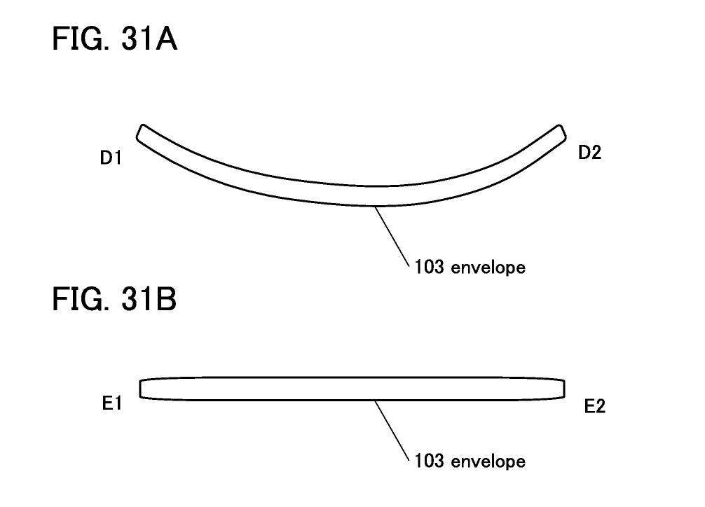

Still alternatively, the bonding portion 108 may be provided in only two sides of the envelope 103 as shown in FIGS. 29A and 29B. In this case, the bonding portion 108 can prevent the negative electrode 102 from being shifted too much when the power storage unit 100 or the envelope 103 is bent as in FIGS. 31A and 31B.

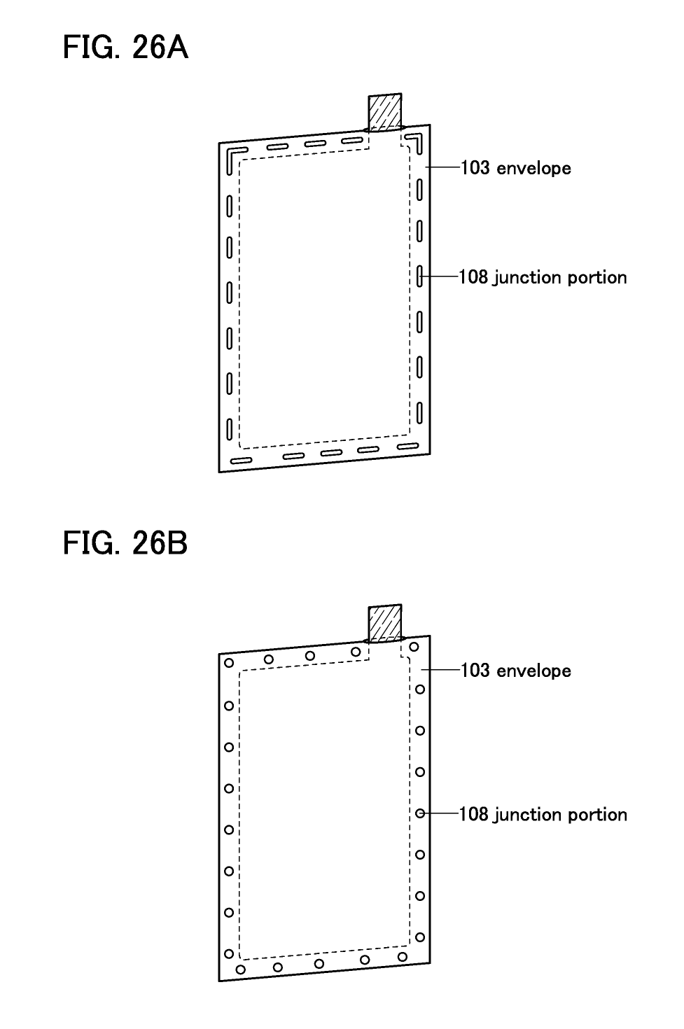

Still further alternatively, the bonding portion 108 may be provided in four sides of the envelope 103 as shown in FIGS. 26A and 26B. In this case, states of the four sides can be made uniform.

Note that a similar bonding portion can be provided also in the case of using the film 113A and the film 113B as shown in FIGS. 25A to 25C. For example, the bonding portion 108 may be provided in four sides of the envelope 103 as shown in FIGS. 26A and 26B.

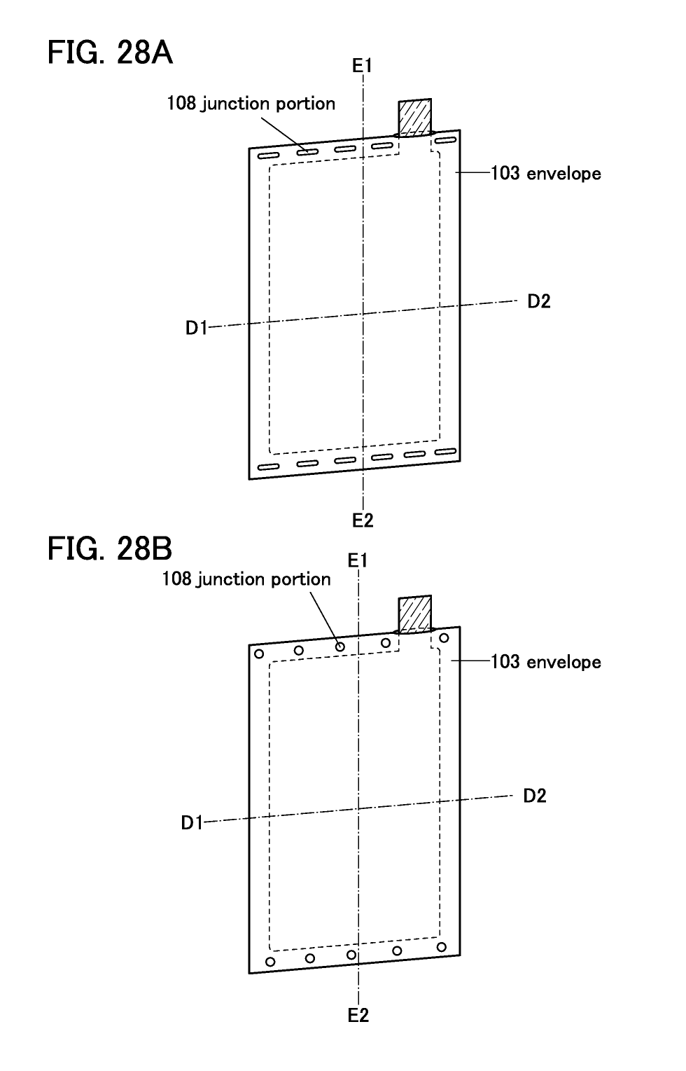

Alternatively, the bonding portion 108 may be provided in only two sides of the envelope 103 as shown in FIGS. 28A and 28B. In this case, the bonding portion 108 can prevent the negative electrode 102 from being shifted too much when the power storage unit 100 or the envelope 103 is bent as in FIGS. 30A and 30B.

Still alternatively, the bonding portion 108 may be provided in only two sides of the envelope 103 as shown in FIGS. 29A and 29B. In this case, the bonding portion 108 can prevent the negative electrode 102 from being shifted too much when the power storage unit 100 or the envelope 103 is bent as in FIGS. 31A and 31B.

Note that in the cases shown in FIGS. 27A and 27B and FIGS. 28A and 28B, the power storage unit 100 or the envelope 103 may be bent as in FIGS. 31A and 31B. Similarly, in the cases shown in FIGS. 29A and 29B, the power storage unit 100 or the envelope 103 may be bent as in FIGS. 30A and 30B.

Note that although the case where the negative electrode 102 is covered by the envelope 103 is shown in FIGS. 3A to 3D and the like, one embodiment of the present invention is not limited thereto. For example, the negative electrode 102 is not necessarily covered by the envelope 103; the positive electrode 101 may be covered by the envelope 103 instead of the negative electrode 102. The positive electrode 101 as well as the negative electrode 102 may also be covered by the envelope 103, for example.

For example, the bonding portions 108 of the positive electrode 101 and the negative electrode 102 may be different in shape and/or arrangement. As a specific example, the shape and/or arrangement of the bonding portion 108 for one of the positive electrode 101 and the negative electrode 102 is as shown in any one of FIG. 3D, FIGS. 8A and 8B, FIG. 25C, FIGS. 26A and 26B, FIGS. 27A and 27B, FIGS. 28A and 28B, and FIGS. 29A and 29B, whereas the shape and/or the arrangement of the bonding portion 108 for the other thereof is as shown in any one of FIG. 3D, FIGS. 8A and 8B, FIG. 25C, FIGS. 26A and 26B, FIGS. 27A and 27B, FIGS. 28A and 28B, and FIGS. 29A and 29B. Furthermore, different shapes and/or arrangements of the bonding portions 108 may be used in combination. As described above, the bonding portion 108 is provided in any of four sides on the positive electrode 101 side or the negative electrode 102 side; thus, the electrode can be prevented from being shifted too much.

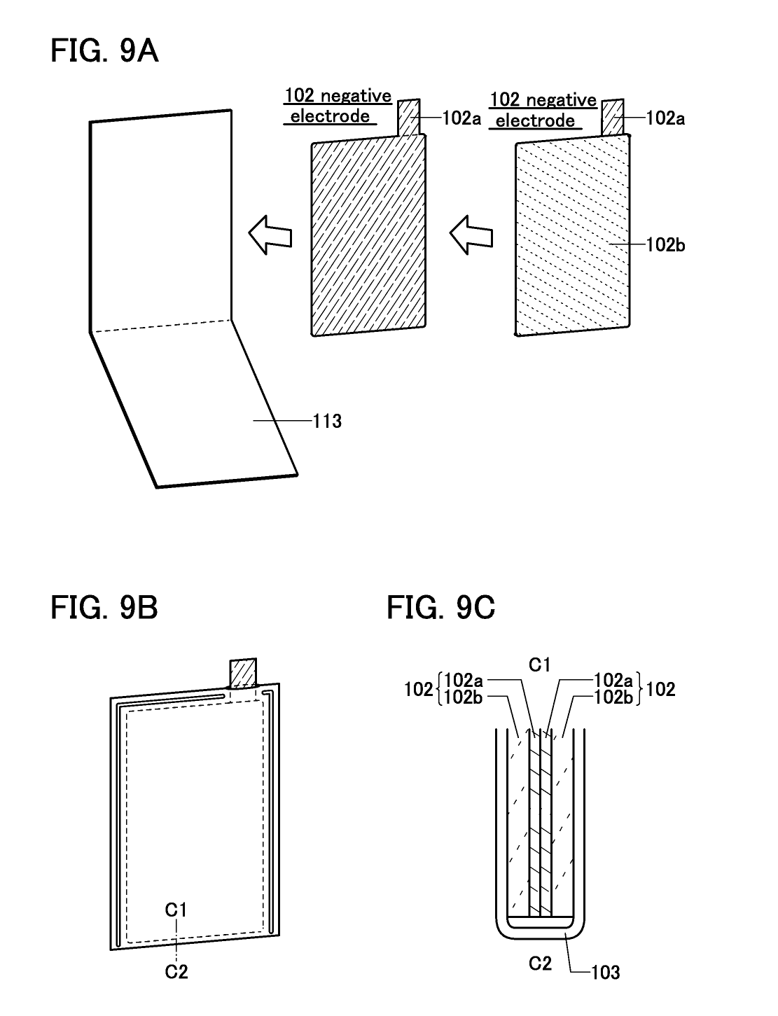

The envelope 103 may cover two negative electrodes 102. In each of the negative electrodes 102, the negative electrode active material layer 102b is provided on one surface of the negative electrode current collector 102a, and the negative electrodes 102 overlap with each other so that surfaces of the negative electrodes 102 on which the negative electrode active material layers 102b are not formed face each other (see FIGS. 9A and 9B). FIG. 9C is an enlarged cross-sectional view of a portion of an element in which the envelope 103 covers the two negative electrodes 102 overlapping with each other as described above. Note that FIG. 9C is a cross-sectional view of a portion indicated by the dashed-dotted line C1-C2 in FIG. 9B.

In the case where the two negative electrodes 102 are provided so that the negative electrode current collectors 102a face each other, the power storage unit 100 can be easily bent without a reduction in the strength of the electrodes.

### 2. CONNECTING NEGATIVE ELECTRODE LEAD TO NEGATIVE ELECTRODE TAB

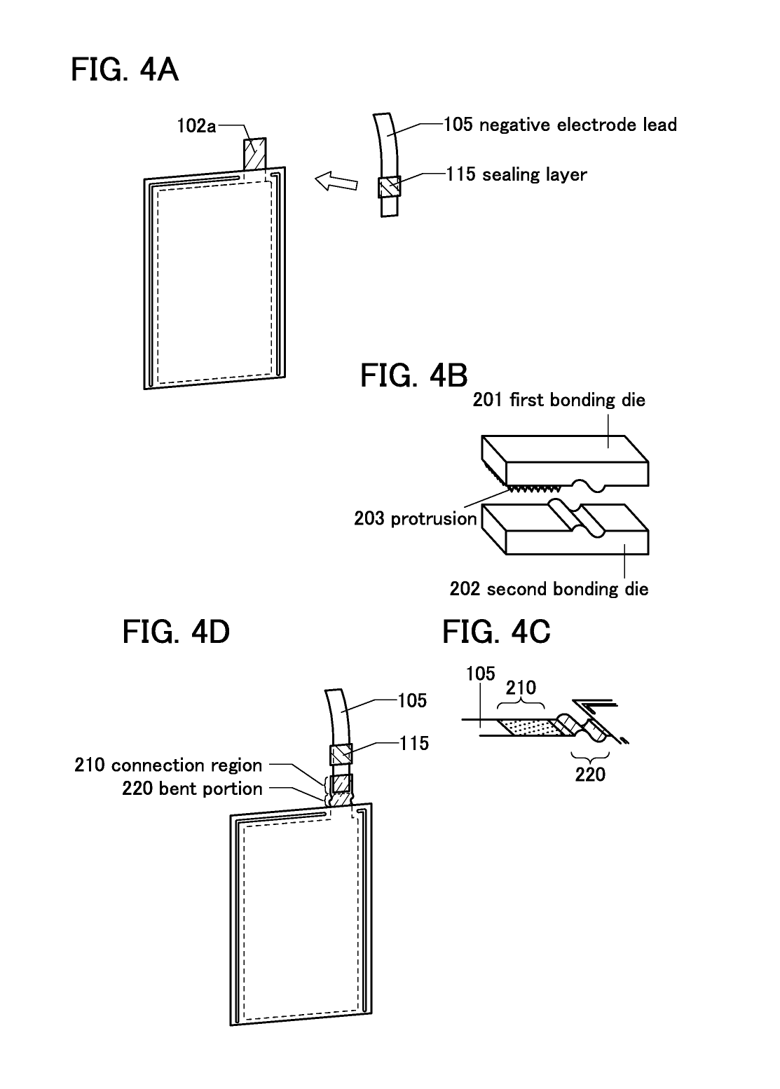

Next, as illustrated in FIGS. 4A-4D, the negative electrode lead 105 including a sealing layer 115 is electrically connected to the negative electrode tab of the negative electrode current collector 102a by irradiation with ultrasonic waves with pressure applied (ultrasonic welding).

The lead electrode is likely to be cracked or cut by stress due to external force applied after manufacture of the power storage unit.

Thus, an ultrasonic welding apparatus including bonding dies illustrated in FIG. 4B is used in this embodiment. Note that only top and bottom bonding dies of the ultrasonic welding apparatus are illustrated in FIG. 4B for simplicity.

The negative electrode tab and the negative electrode lead 105 are positioned between a first bonding die 201 provided with projections 203 and a second bonding die 202. When ultrasonic welding is performed with a region to be connected overlapping with the projections 203, a connection region 210 and a bent portion 220 can be formed in the negative electrode tab. FIG. 4C is a perspective view in which the connection region 210 and the bent portion 220 of the negative electrode tab are enlarged.

This bent portion 220 can relieve stress due to external force applied after manufacture of the power storage unit 100. Therefore, the power storage unit 100 can have high reliability.

Furthermore, the ultrasonic welding apparatus including the bonding dies illustrated in FIG. 4B can perform ultrasonic welding and form the bent portion 220 at a time; thus, a secondary battery can be manufactured without increasing the number of manufacturing steps. Note that ultrasonic welding and forming the bent portion 220 may be separately performed.

The bent portion 220 is not necessarily formed in the negative electrode tab. The negative electrode current collector may be formed using a high-strength material such as stainless steel to a thickness of 10 μm or less, in order to easily relieve stress due to external force applied after manufacture of a secondary battery.

It is needless to say that two or more of the above examples may be combined to relieve concentration of stress in the negative electrode tab.

Note that although the case of the negative electrode is described in these examples, the positive electrode may be manufactured in a manner similar to that of the negative electrode.

### 3. CONNECTING POSITIVE ELECTRODE LEAD TO POSITIVE ELECTRODE TAB

Next, the positive electrode lead 104 including the sealing layer 115 is electrically connected to the positive electrode tab of the positive electrode current collector 101a. The connection of the positive electrode lead 104 to the positive electrode tab can be performed in a manner similar to the connection of the negative electrode lead 105 to the negative electrode tab.

### 4. COVERING POSITIVE ELECTRODE AND NEGATIVE ELECTRODE BY EXTERIOR BODY

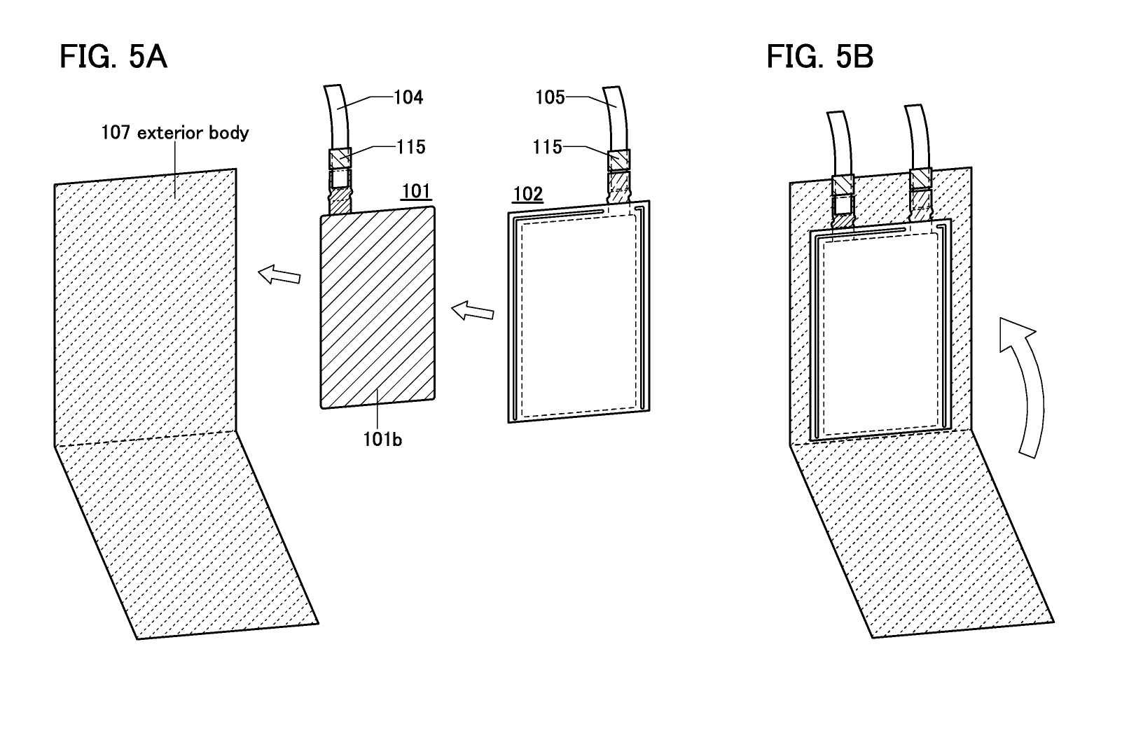

Next, the positive electrode 101 and the negative electrode 102 covered by the envelope 103 overlap with each other over a surface of the exterior body 107 so that the positive electrode active material layer 101b and the negative electrode active material layer 102b face each other (see FIG. 5A).

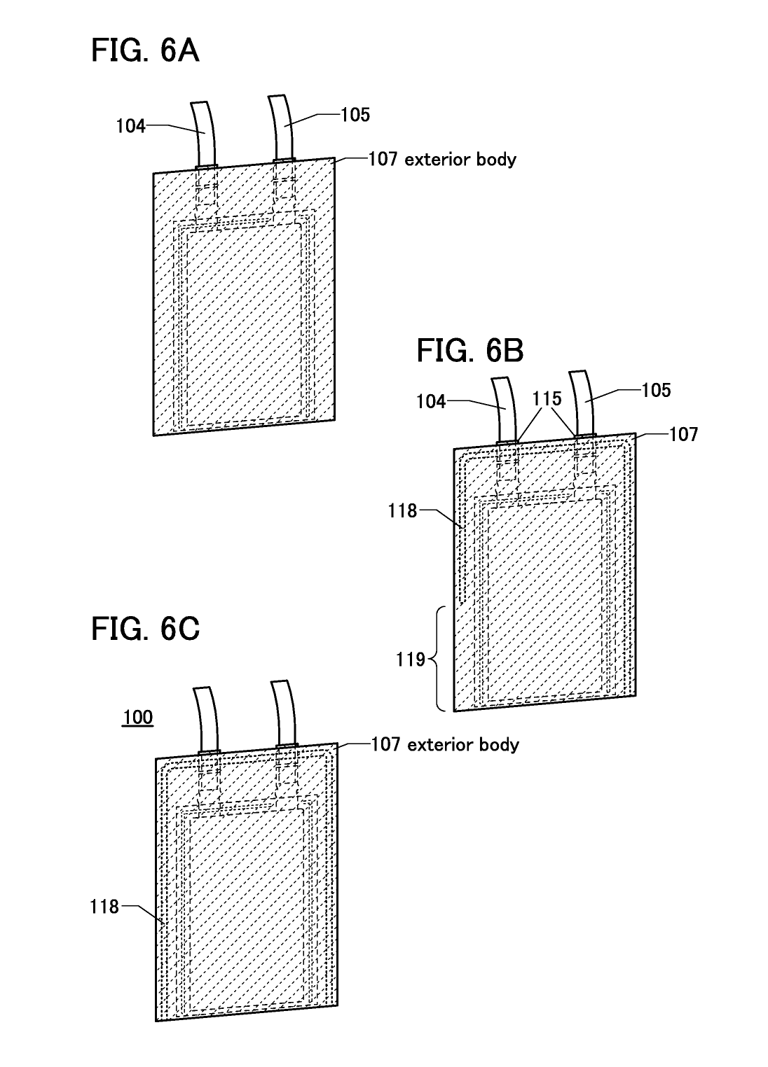

Then, the exterior body 107 is folded along a portion indicated by the dotted line in the middle of the exterior body 107 shown in FIG. 5A (see FIG. 5B) so as to be in the state shown in FIG. 6A.

### 5. INTRODUCING ELECTROLYTE SOLUTION TO EXTERIOR BODY

The outer edges of the exterior body 107 except the introduction port 119 for introducing the electrolyte solution 106 are bonded to each other by thermocompression bonding. In thermocompression bonding, the sealing layers 115 provided over the lead electrodes are also melted, thereby fixing the lead electrodes and the exterior body 107 to each other. A portion where the outer edges of the exterior body 107 are bonded by thermocompression bonding is shown as a bonding portion 118 in FIG. 6B.

After that, in a reduced-pressure atmosphere or an inert atmosphere, a desired amount of electrolyte solution is introduced to the inside of the exterior body 107 through the introduction port 119. Finally, the introduction port 119 is sealed by thermocompression bonding. In the above-described manner, the power storage unit 100 can be manufactured (see FIG. 6C).

### 6. MODIFICATION EXAMPLE

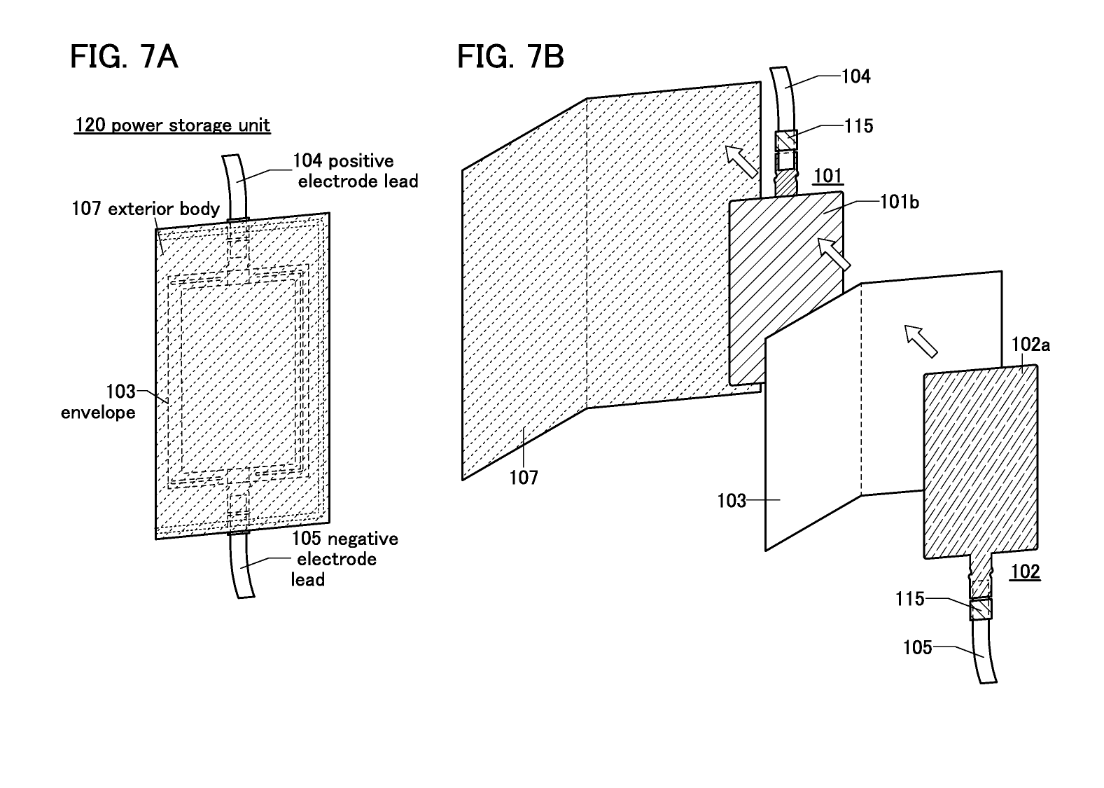

FIG. 7A shows a power storage unit 120 as a modification example of the power storage unit 100. The power storage unit 120 shown in FIG. 7A is different from the power storage unit 100 in the positions of the positive electrode lead 104 and the negative electrode lead 105. Specifically, the positive electrode lead 104 and the negative electrode lead 105 in the power storage unit 100 are provided on the same side of the exterior body 107, whereas the positive electrode lead 104 and the negative electrode lead 105 in the power storage unit 120 are provided on different sides of the exterior body 107. The lead electrodes of a power storage unit of one embodiment of the present invention can be freely positioned as described above; therefore, the degree of freedom in design is high. Accordingly, a product including a power storage unit of one embodiment of the present invention can have a high degree of freedom in design. Furthermore, production efficiency of products each including a power storage unit of one embodiment of the present invention can be increased.

FIG. 7B illustrates a manufacturing process of the power storage unit 120. The power storage unit 120 can be manufactured using a material and a method similar to those used for the power storage unit 100, and thus, detailed description thereof is skipped. Note that in FIG. 7B, the electrolyte solution 106 is omitted.

This embodiment can be implemented in appropriate combination with any of the other embodiments.

### Embodiment 3

In this embodiment, a power storage unit 150 is described with reference to drawings. A structure of the power storage unit 150 is different from that of the power storage unit 100 described in the above embodiments. Note that as the perspective view of the power storage unit 150, the perspective view illustrated in FIG. 1 is referred to because the appearance of the power storage unit 150 is the same as that of the power storage unit 100.

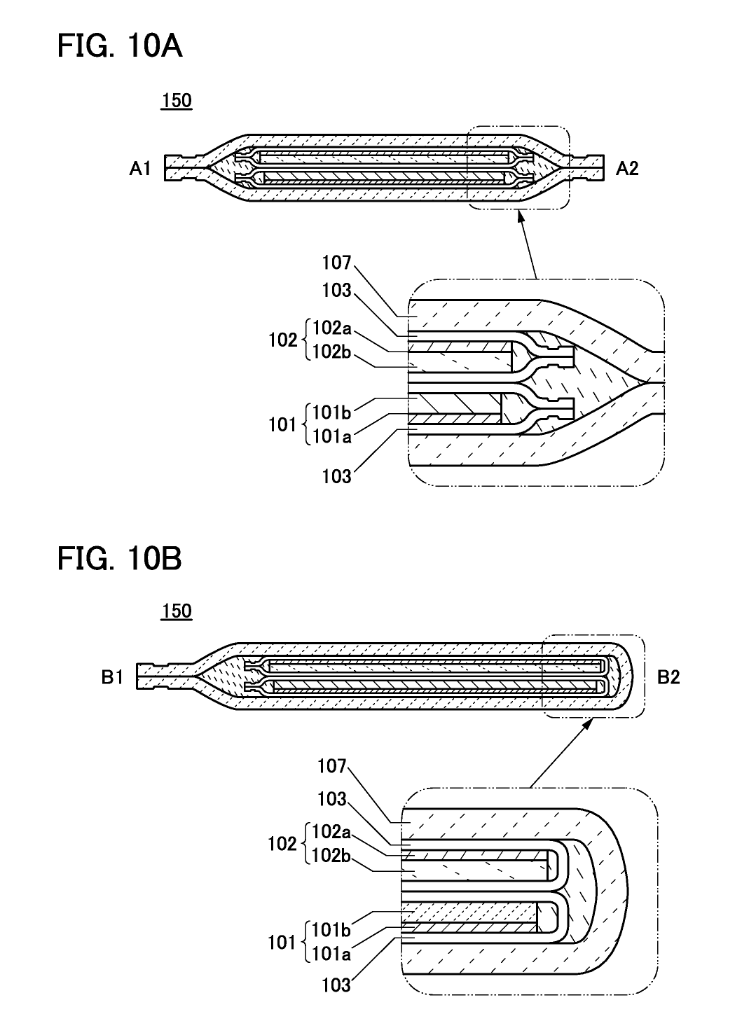

In the power storage unit 150 of one embodiment of the present invention, each of the positive electrode 101 and the negative electrode 102 is covered by the envelope 103. FIGS. 10A and 10B are cross-sectional views of the power storage unit 150.

FIG. 10A corresponds to a cross section of a portion indicated by the dashed-dotted line A1-A2 in FIG. 1. FIG. 10B corresponds to a cross section of a portion indicated by the dashed-dotted line B1-B2 in FIG. 1. In FIGS. 10A and 10B, the envelope 103 covering the positive electrode 101 is in contact with the envelope 103 covering the negative electrode 102.

Note that the envelope 103 covering the positive electrode 101 and the envelope 103 covering the negative electrode 102 do not necessarily include the same material. For example, the envelope 103 covering the positive electrode 101 may include a material suitable for the positive electrode 101, and the envelope 103 covering the negative electrode 102 may include a material suitable for the negative electrode 102. The use of different materials for the envelopes 103 in this manner allows the structure to be optimum. For example, the envelope 103 covering the negative electrode 102 may include at least one material selected from the following: a porous insulator such as cellulose, polypropylene (PP), polyethylene (PE), polybutene, nylon, polyester, polysulfone, polyacrylonitrile, polyvinylidene fluoride, or tetrafluoroethylene; nonwoven fabric of a glass fiber or the like; and a diaphragm in which a glass fiber and a polymer fiber are mixed. The envelope 103 covering the positive electrode 101 may include at least one material selected from the following: a porous insulator such as cellulose, polypropylene (PP), polyethylene (PE), polybutene, nylon, polyester, polysulfone, polyacrylonitrile, polyvinylidene fluoride, or tetrafluoroethylene; nonwoven fabric of a glass fiber or the like; and a diaphragm in which a glass fiber and a polymer fiber are mixed.

The structure in which each of the positive electrode 101 and the negative electrode 102 is covered by the envelope 103 can further increase reliability of the power storage unit.

Note that a structure in which the positive electrode 101 is covered by the envelope 103 and a formation method thereof can be described by replacing the “negative electrode 102” in the above embodiments with the “positive electrode 101”. Note that a structure in which the positive electrode 101 is covered by the envelope 103 and the negative electrode 102 is not covered by the envelope 103 may be used.

This embodiment can be implemented in appropriate combination with any of the other embodiments.

### Embodiment 4

In this embodiment, a power storage unit 160 and a power storage unit 170 are described with reference to drawings. The power storage unit 160 and the power storage unit 170 have higher storage capacity than the power storage unit 100 and the power storage unit 150. Note that as the perspective view of each of the power storage unit 160 and the power storage unit 170, the perspective view illustrated in FIG. 1 is referred to because the appearance of each of the power storage unit 160 and the power storage unit 170 is the same as that of the power storage unit 100.

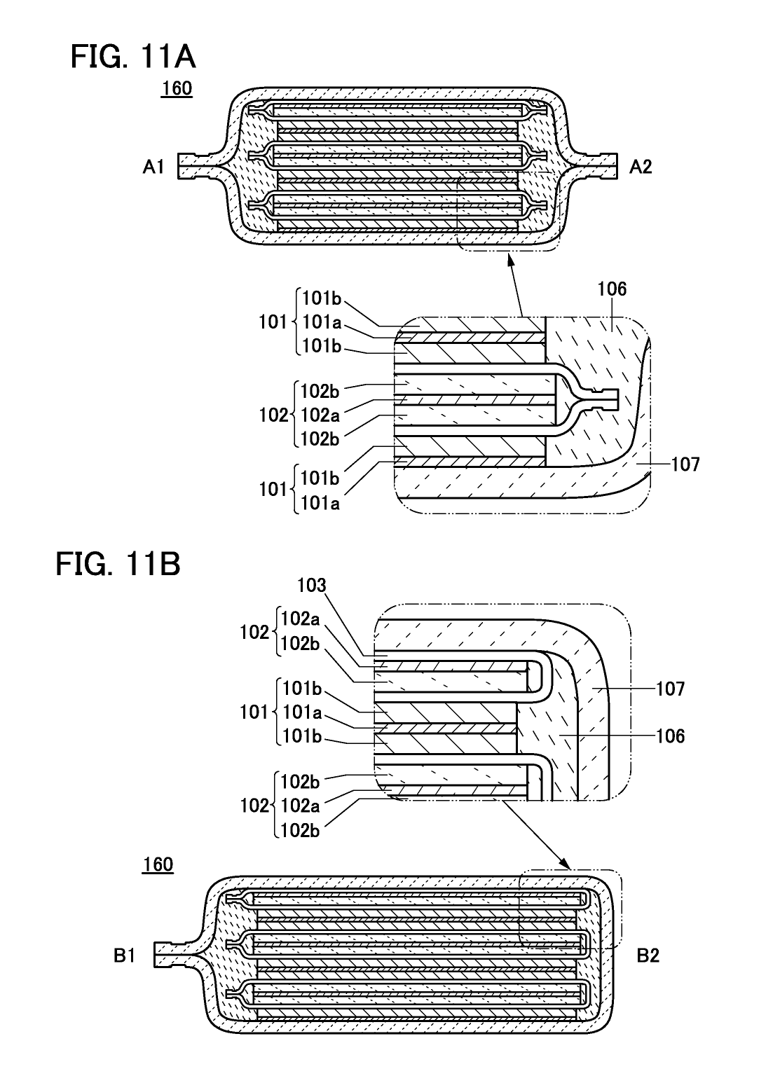

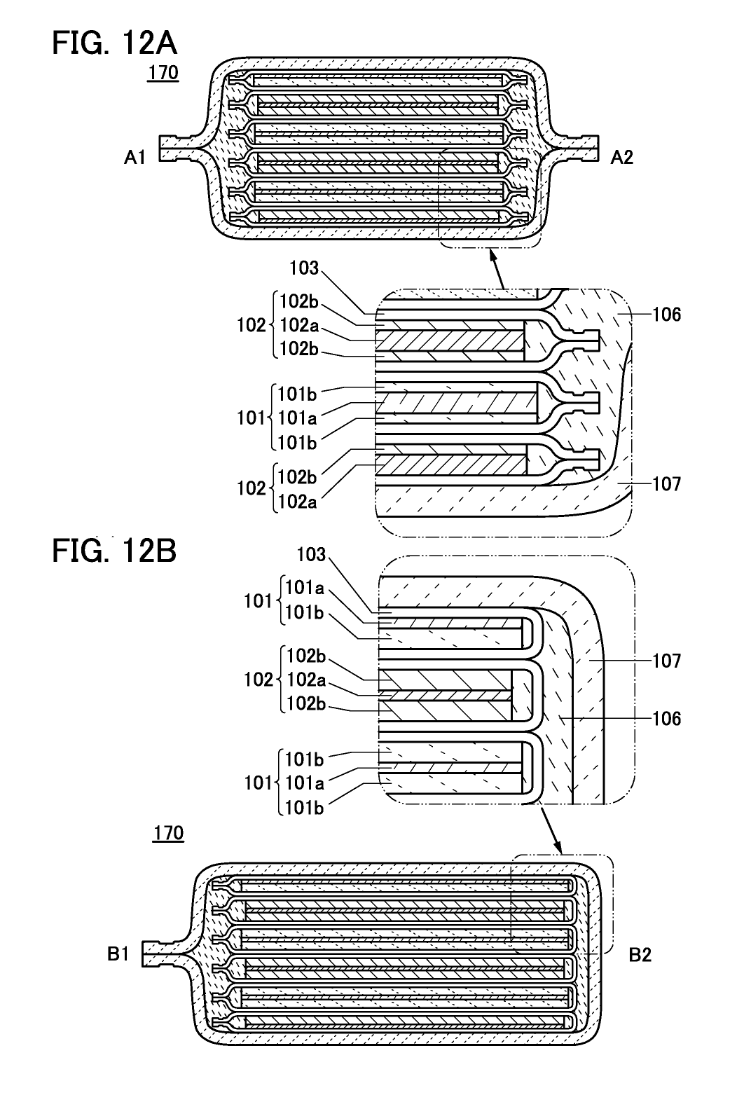

FIGS. 11A and 11B are cross-sectional views of the power storage unit 160. FIG. 11A corresponds to a cross section of a portion indicated by the dashed-dotted line A1-A2 in FIG. 1. FIG. 11B corresponds to a cross section of a portion indicated by the dashed-dotted line B1-B2 in FIG. 1. FIGS. 12A and 12B are cross-sectional views of the power storage unit 170. FIG. 12A corresponds to a cross section of a portion indicated by the dashed-dotted line A1-A2 in FIG. 1. FIG. 12B corresponds to a cross section of a portion indicated by the dashed-dotted line B1-B2 in FIG. 1.

In examples of the power storage unit 160 and the power storage unit 170, two positive electrodes 101 and two negative electrodes 102 are alternated between a positive electrode 101 in which the positive electrode active material layer 101b is provided on only one surface of the positive electrode current collector 101a and a negative electrode 102 in which the negative electrode active material layer 102b is provided on only one surface of the negative electrode current collector 102a. In each of the two positive electrodes 101, the positive electrode active material layer 101b is provided on both surfaces of the positive electrode current collector 101a. In each of the two negative electrodes 102, the negative electrode active material layer 102b is provided on both surfaces of the negative electrode current collector 102a.

In the power storage unit 160, the positive electrode 101 is not covered by the envelope 103 and the negative electrode 102 is covered by the envelope 103. In the power storage unit 170, each of the positive electrode 101 and the negative electrode 102 is covered by the envelope 103.

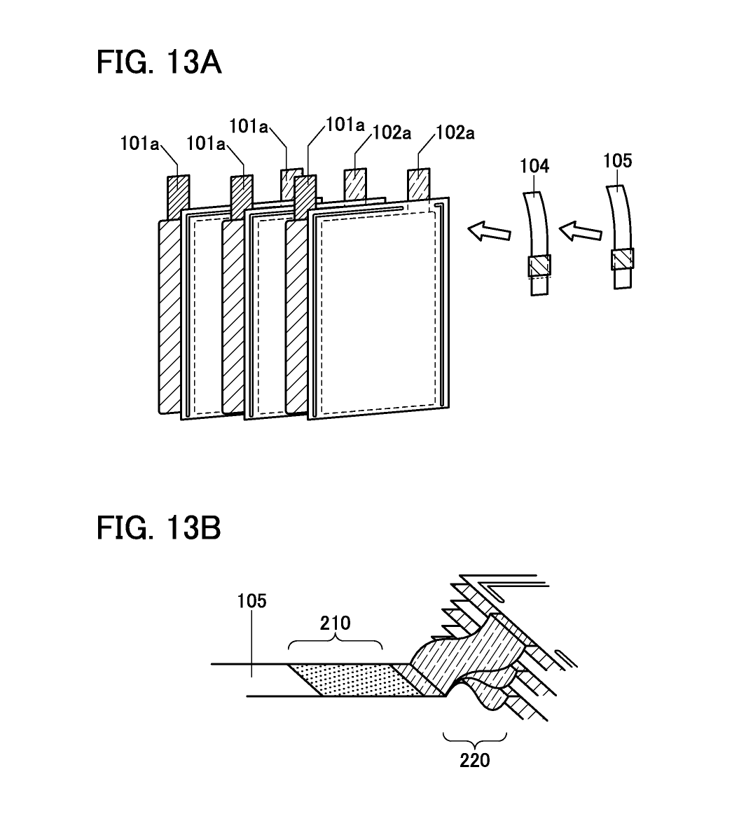

In the case of manufacturing the power storage unit 160 and the power storage unit 170, a plurality of positive electrode tabs is preferably connected to one positive electrode lead 104 at a time as illustrated in FIG. 13A after a plurality of pairs of the positive electrode 101 and the negative electrode 102 overlaps with each other. Furthermore, negative electrode tabs are preferably connected to one negative electrode lead 105 at a time. The connection between the positive electrode tabs and the positive electrode lead 104 and the connection between the negative electrode tabs and the negative electrode lead 105 can be performed using the ultrasonic welding apparatus including the bonding dies as described in the above embodiment. FIG. 13B is a perspective view in which the connection region 210 and the bent portion 220 of the negative electrode tab are enlarged. Connecting a plurality of positive electrode tabs to one positive electrode lead 104 at a time can increase production efficiency of power storage units. Furthermore, connecting a plurality of negative electrode tabs to one negative electrode lead 105 can increase production efficiency of power storage units.

The power storage unit in which a plurality of pairs of the positive electrode 101 and the negative electrode 102 is stored in the exterior body 107 can have high capacity.

The structure in which each of the positive electrode 101 and the negative electrode 102 is covered by the envelope 103 can further increase reliability of the power storage unit.

This embodiment can be implemented in appropriate combination with any of the other embodiments.

### Embodiment 5

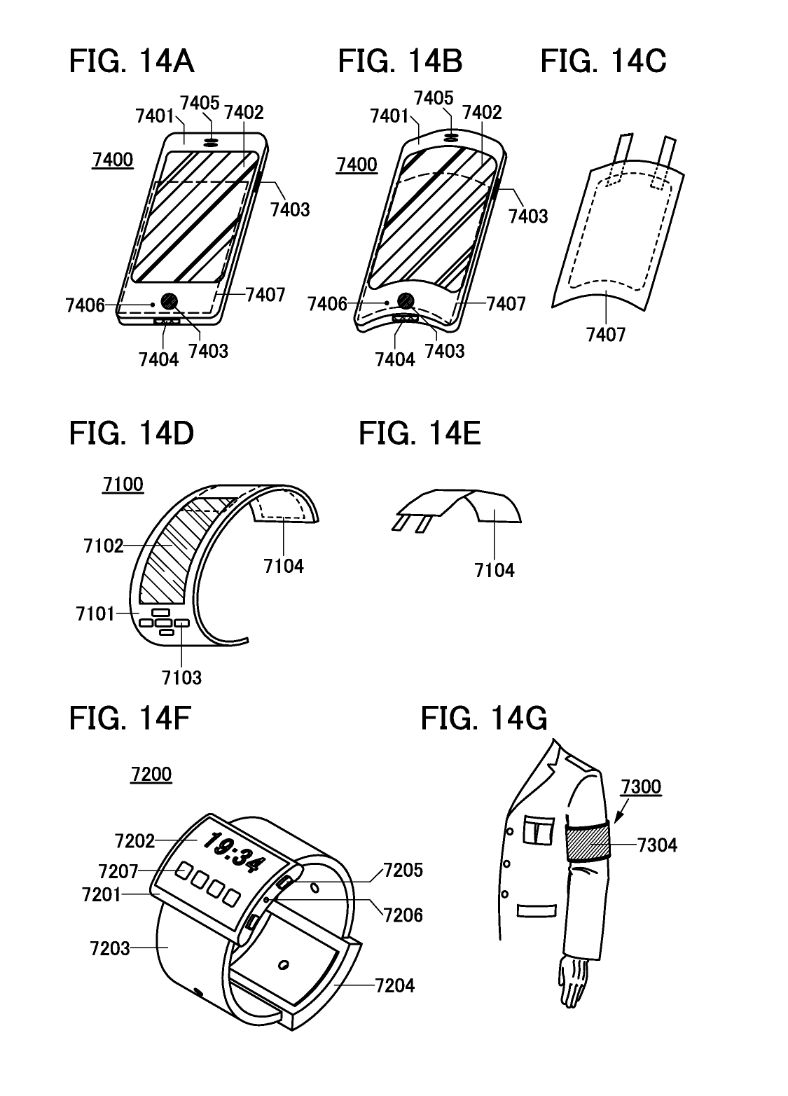

The power storage unit of one embodiment of the present invention can be used as a power storage device of various electronic devices which are driven by electric power. FIGS. 14A to 14G, FIGS. 15A to 15C, FIG. 16, and FIGS. 17A and 17B illustrate specific examples of the electronic devices using a power storage device of one embodiment of the present invention.

Specific examples of the electronic devices using the power storage device of one embodiment of the present invention are as follows: display devices of televisions, monitors, and the like, lighting devices, desktop and laptop personal computers, word processors, image reproduction devices which reproduce still images and moving images stored in recording media such as digital versatile discs (DVDs), portable CD players, radios, tape recorders, headphone stereos, stereos, table clocks, wall clocks, cordless phone handsets, transceivers, mobile phones, car phones, portable game machines, tablet terminals, large game machines such as pachinko machines, calculators, portable information terminals, electronic notebooks, e-book readers, electronic translators, audio input devices, video cameras, digital still cameras, electric shavers, high-frequency heating appliances such as microwave ovens, electric rice cookers, electric washing machines, electric vacuum cleaners, water heaters, electric fans, hair dryers, air-conditioning systems such as air conditioners, humidifiers, and dehumidifiers, dishwashers, dish dryers, clothes dryers, futon dryers, electric refrigerators, electric freezers, electric refrigerator-freezers, freezers for preserving DNA, flashlights, electrical tools such as a chain saw, smoke detectors, and medical equipment such as dialyzers. Other examples are as follows: industrial equipment such as guide lights, traffic lights, conveyor belts, elevators, escalators, industrial robots, and power storage systems, and industrial equipment for leveling the amount of power supply and smart grid. In addition, moving objects and the like driven by electric motors using power from a power storage device are also included in the category of electronic devices. Examples of the moving objects include electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, motorized bicycles including motor-assisted bicycles, motorcycles, electric wheelchairs, golf carts, boats, ships, submarines, helicopters, aircrafts, rockets, artificial satellites, space probes, planetary probes, and spacecrafts.

In addition, the power storage device of one embodiment of the present invention can be incorporated along a curved inside/outside wall surface of a house or a building or a curved interior/exterior surface of a car.

FIG. 14A illustrates an example of a mobile phone. A mobile phone 7400 includes a display portion 7402 incorporated in a housing 7401, an operation button 7403, an external connection port 7404, a speaker 7405, a microphone 7406, and the like. Note that the mobile phone 7400 includes a power storage device 7407.

The mobile phone 7400 illustrated in FIG. 14B is bent. When the whole mobile phone 7400 is bent by the external force, the power storage device 7407 included in the mobile phone 7400 is also bent. FIG. 14C illustrates the bent power storage device 7407.

FIG. 14D illustrates an example of a bangle display device. A portable display device 7100 includes a housing 7101, a display portion 7102, an operation button 7103, and a power storage device 7104. FIG. 14E illustrates the bent power storage device 7104.

FIG. 14F illustrates an example of a wrist-watch-type portable information terminal. A portable information terminal 7200 includes a housing 7201, a display portion 7202, a band 7203, a buckle 7204, an operation button 7205, an input output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is bent, and images can be displayed on the bent display surface. Further, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as power ON/OFF, ON/OFF of wireless communication, setting and cancellation of manner mode, and setting and cancellation of power saving mode can be performed. For example, the functions of the operation button 7205 can be set freely by setting the operation system incorporated in the portable information terminal 7200.

Further, the portable information terminal 7200 can employ near field communication that is a communication method based on an existing communication standard. In that case, for example, mutual communication between the portable information terminal 7200 and a headset capable of wireless communication can be performed, and thus hands-free calling is possible.

Moreover, the portable information terminal 7200 includes the input output terminal 7206, and data can be directly transmitted to and received from another information terminal via a connector. Power charging through the input output terminal 7206 is possible. Note that the charging operation may be performed by wireless power feeding without using the input output terminal 7206.

The portable information terminal 7200 includes the power storage device of one embodiment of the present invention. For example, the power storage device 7104 shown in FIG. 14E can be incorporated in the housing 7201 with a state where the power storage device 7104 is bent or can be incorporated in the band 7203 with a state where the power storage device 7104 can be bent.

FIG. 14G illustrates an example of an armband display device. A display device 7300 includes a display portion 7304 and the power storage device of one embodiment of the present invention. The display device 7300 can include a touch sensor in the display portion 7304 and can serve as a portable information terminal.

The display surface of the display portion 7304 is bent, and images can be displayed on the bent display surface. A display state of the display device 7300 can be changed by, for example, near field communication that is a communication method in accordance with an existing communication standard.

The display device 7300 includes an input output terminal, and data can be directly transmitted to and received from another information terminal via a connector.

Power charging through the input output terminal is possible. Note that the charging operation may be performed by wireless power feeding without using the input output terminal.

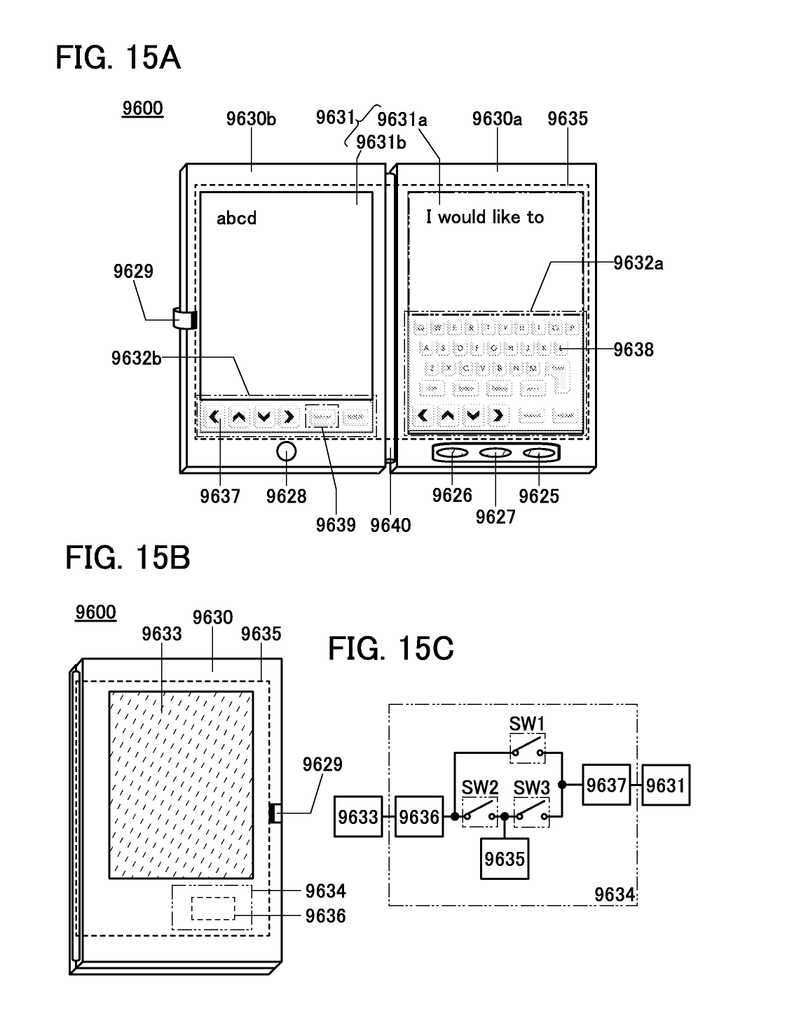

FIGS. 15A and 15B illustrate an example of a foldable tablet terminal. A tablet terminal 9600 illustrated in FIGS. 15A and 15B includes a housing 9630 provided with a housing 9630a and a housing 9630b, a movable portion 9640 connecting the housings 9630a and 9630b, a display portion 9631 provided with a display portion 9631a and a display portion 9631b, a display mode switch 9626, a power switch 9627, a power saver switch 9625, a fastener 9629, and an operation switch 9628. FIGS. 15A and 15B illustrate the tablet terminal 9600 opened and closed, respectively.

The tablet terminal 9600 includes a power storage device 9635 inside the housings 9630a and 9630b. The power storage device 9635 is provided across the housings 9630a and 9630b, passing through the movable portion 9640.

Part of the display portion 9631 a can be a touch panel region 9632a and data can be input when a displayed operation key 9638 is touched. FIG. 15A shows, as an example, a structure in which a half region in the display portion 9631 a has only a display function and the other half region has a touch panel function. The whole area of the display portion 9631 a may have a touch panel function. For example, the whole area of the display portion 9631 a can display keyboard buttons and serve as a touch panel while the display portion 9631b can be used as a display screen.

As in the display portion 9631a, part of the display portion 9631b can be a touch panel region 9632b. When a keyboard display switching button 9639 displayed on the touch panel is touched with a finger, a stylus, or the like, a keyboard can be displayed on the display portion 9631b.

Touch input can be performed in the touch panel region 9632a and the touch panel region 9632b at the same time.

The display mode switch 9626 can switch the display between portrait mode, landscape mode, and the like, and between monochrome display and color display, for example. The power saver switch 9625 can control display luminance in accordance with the amount of external light in use of the tablet terminal 9600, which is measured with an optical sensor incorporated in the tablet terminal 9600. The tablet terminal may include another detection device such as a gyroscope or an acceleration sensor in addition to the optical sensor.

FIG. 15A illustrates, but is not limited to, an example in which the display portions 9631a and 9631b have the same display area. The display portions 9631a and 9631b may have different display areas and different display quality. For example, higher-resolution images may be displayed on one of the display portions 9631a and 9631b.

The tablet terminal is closed in FIG. 15B. The tablet terminal includes the housing 9630, a solar cell 9633, and a charge and discharge control circuit 9634 including a DC-DC converter 9636. The power storage unit of one embodiment of the present invention can be used for the power storage device 9635.

The tablet terminal 9600 can be folded in two so that the housings 9630a and 9630b overlap with each other when not in use. Thus, the display portions 9631a and 9631b can be protected, which increases the durability of the tablet terminal 9600. In addition, the power storage device 9635 of one embodiment of the present invention has flexibility and can be repeatedly bent without a large decrease in charge and discharge capacity. Thus, a highly reliable tablet terminal can be provided.

The tablet terminal illustrated in FIGS. 15A and 15B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal, supplies electric power to a touch panel, a display portion, an image signal processor, and the like. Note that the solar cell 9633 can be provided on one or both surfaces of the housing 9630 and the power storage device 9635 can be charged efficiently. The use of a lithium-ion battery as the power storage device 9635 brings an advantage such as a reduction in size.

The structure and operation of the charge and discharge control circuit 9634 in FIG. 15B are described with reference to a block diagram in FIG. 15C. The solar cell 9633, the power storage device 9635, the DC-DC converter 9636, a converter 9637, switches SW1 to SW3, and the display portion 9631 are illustrated in FIG. 15C, and the power storage device 9635, the DC-DC converter 9636, the converter 9637, and the switches SW1 to SW3 correspond to the charge and discharge control circuit 9634 in FIG. 15B.

First, an example of the operation in the case where electric power is generated by the solar cell 9633 using external light is described. The voltage of electric power generated by the solar cell is raised or lowered by the DC-DC converter 9636 to a voltage for charging the power storage device 9635. Then, when the electric power from the solar cell 9633 is used for the operation of the display portion 9631, the switch SW1 is turned on and the voltage of the electric power is raised or lowered by the converter 9637 to a voltage needed for the display portion 9631. When display on the display portion 9631 is not performed, the switch SW1 is turned off and the switch SW2 is turned on, so that the power storage device 9635 can be charged.

Note that the solar cell 9633 is described as an example of a power generation means; however, one embodiment of the present invention is not limited to this example. The power storage device 9635 may be charged using another power generation means such as a piezoelectric element or a thermoelectric conversion element (Peltier element). For example, the power storage device 9635 may be charged using a non-contact power transmission module that transmits and receives electric power wirelessly (without contact) or using another charging means in combination.

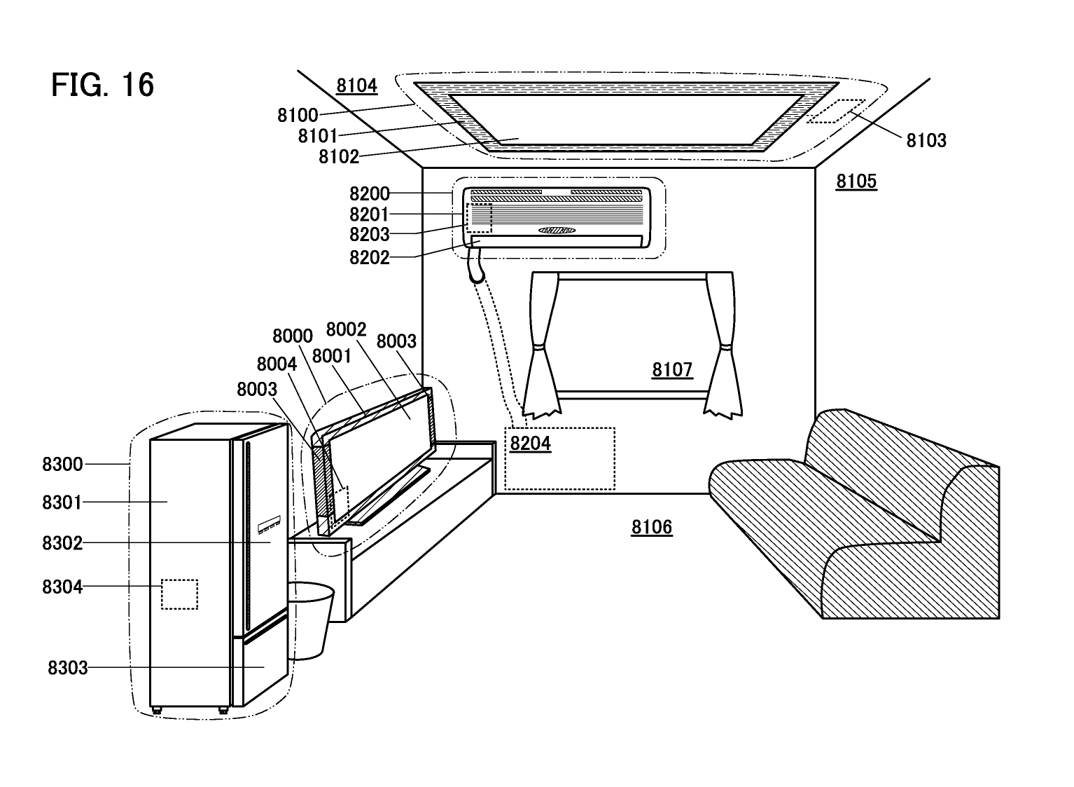

FIG. 16 illustrates examples of other electronic devices. In FIG. 16, a display device 8000 is an example of an electronic device including a power storage device 8004 of one embodiment of the present invention. Specifically, the display device 8000 corresponds to a display device for TV broadcast reception and includes a housing 8001, a display portion 8002, speaker portions 8003, the power storage device 8004, and the like. The power storage device 8004 of one embodiment of the present invention is provided in the housing 8001. The display device 8000 can receive electric power from a commercial power source or use electric power stored in the power storage device 8004. Thus, the display device 8000 can operate with the use of the power storage device 8004 of one embodiment of the present invention as an uninterruptible power source even when electric power cannot be supplied from a commercial power source because of power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all information display devices for personal computers, advertisement displays, and the like besides the ones for TV broadcast reception.

In FIG. 16, an installation lighting device 8100 is an example of an electronic device including a power storage device 8103 of one embodiment of the present invention. Specifically, the lighting device 8100 includes a housing 8101, a light source 8102, the power storage device 8103, and the like. Although FIG. 16 illustrates the case where the power storage device 8103 is provided in a ceiling 8104 on which the housing 8101 and the light source 8102 are installed, the power storage device 8103 may be provided in the housing 8101. The lighting device 8100 can receive electric power from a commercial power source or use electric power stored in the power storage device 8103. Thus, the lighting device 8100 can operate with the use of the power storage device 8103 of one embodiment of the present invention as an uninterruptible power source even when electric power cannot be supplied from a commercial power source because of power failure or the like.

Note that although the installation lighting device 8100 provided in the ceiling 8104 is illustrated in FIG. 16 as an example, the power storage device of one embodiment of the present invention can be used in an installation lighting device provided in, for example, a wall 8105, a floor 8106, a window 8107, or the like besides the ceiling 8104. Alternatively, the power storage device can be used in a tabletop lighting device or the like.

As the light source 8102, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 16, an air conditioner including an indoor unit 8200 and an outdoor unit 8204 is an example of an electronic device including a power storage device 8203 of one embodiment of the present invention. Specifically, the indoor unit 8200 includes a housing 8201, an air outlet 8202, the power storage device 8203, and the like. Although FIG. 16 illustrates the case where the power storage device 8203 is provided in the indoor unit 8200, the power storage device 8203 may be provided in the outdoor unit 8204. Alternatively, the power storage device 8203 may be provided in both the indoor unit 8200 and the outdoor unit 8204. The air conditioner can receive electric power from a commercial power source or use electric power stored in the power storage device 8203. Particularly in the case where the power storage device 8203 is provided in both the indoor unit 8200 and the outdoor unit 8204, the air conditioner can operate with the use of the power storage device 8203 of one embodiment of the present invention as an uninterruptible power source even when electric power cannot be supplied from a commercial power source because of power failure or the like.

Note that although the split-type air conditioner including the indoor unit and the outdoor unit is illustrated in FIG. 16 as an example, the power storage device of one embodiment of the present invention can be used in an air conditioner in which the functions of an indoor unit and an outdoor unit are integrated in one housing.

In FIG. 16, an electric refrigerator-freezer 8300 is an example of an electronic device including a power storage device 8304 of one embodiment of the present invention. Specifically, the electric refrigerator-freezer 8300 includes a housing 8301, a door for a refrigerator 8302, a door for a freezer 8303, the power storage device 8304, and the like. The power storage device 8304 is provided in the housing 8301 in FIG. 16. The electric refrigerator-freezer 8300 can receive electric power from a commercial power source or use electric power stored in the power storage device 8304. Thus, the electric refrigerator-freezer 8300 can operate with the use of the power storage device 8304 of one embodiment of the present invention as an uninterruptible power source even when electric power cannot be supplied from a commercial power source because of power failure or the like.

Note that among the electronic devices described above, the high-frequency heating appliances such as microwave ovens, the electric rice cookers, and the like require high electric power in a short time. The tripping of a circuit breaker of a commercial power source in use of the electronic devices can be prevented by using the power storage device of one embodiment of the present invention as an auxiliary power source for making up for the shortfall in electric power supplied from a commercial power source.

In addition, in a time period when electronic devices are not used, specifically when the proportion of the amount of electric power which is actually used to the total amount of electric power which can be supplied from a commercial power source (such a proportion is referred to as power usage rate) is low, electric power can be stored in the power storage device, whereby the power usage rate can be reduced in a time period when the electronic devices are used. For example, in the case of the electric refrigerator-freezer 8300, electric power can be stored in the power storage device 8304 in night time when the temperature is low and the door for a refrigerator 8302 and the door for a freezer 8303 are not often opened or closed. On the other hand, in daytime when the temperature is high and the door for a refrigerator 8302 and the door for a freezer 8303 are frequently opened and closed, the power storage device 8304 is used as an auxiliary power source; thus, the power usage rate in daytime can be reduced.

The use of a power storage device in vehicles can lead to next-generation clean energy vehicles such as hybrid electric vehicles (HEVs), electric vehicles (EVs), and plug-in hybrid electric vehicles (PHEVs).

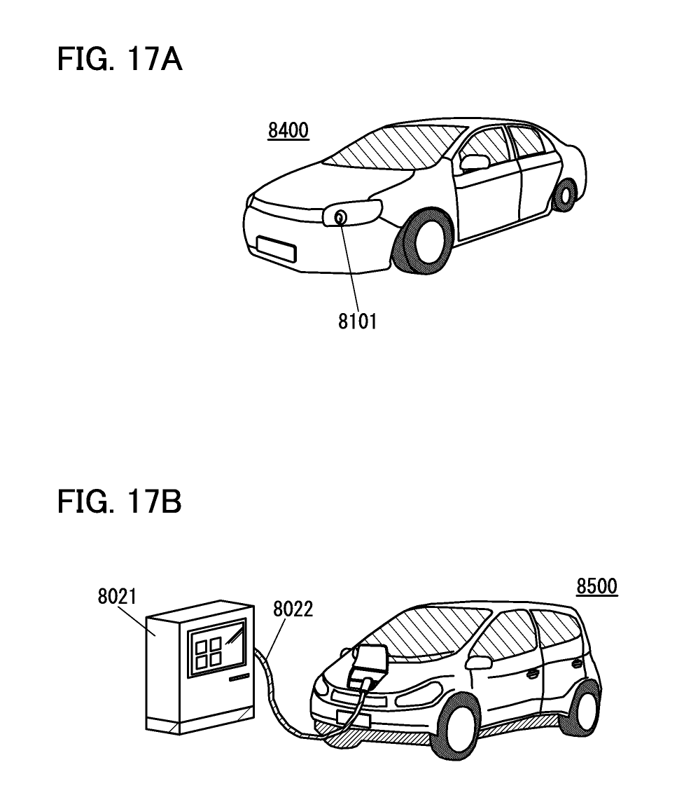

FIGS. 17A and 17B each illustrate an example of a vehicle using one embodiment of the present invention. An automobile 8400 illustrated in FIG. 17A is an electric vehicle which runs on the power of the electric motor. Alternatively, the automobile 8400 is a hybrid electric vehicle capable of driving using either the electric motor or the engine as appropriate. One embodiment of the present invention achieves a high-mileage vehicle. The automobile 8400 includes the power storage device. The power storage device is used not only for driving the electric motor, but also for supplying electric power to a light-emitting device such as a headlight 8401 or a room light (not illustrated).

The power storage device can also supply electric power to a display device included in the automobile 8400, such as a speedometer or a tachometer. Furthermore, the power storage device can supply electric power to a semiconductor device included in the automobile 8400, such as a navigation system.

FIG. 17B illustrates an automobile 8500 including the power storage device. The automobile 8500 can be charged when the power storage device is supplied with electric power through external charging equipment by a plug-in system, a contactless power supply system, or the like. In FIG. 17B, the power storage device included in the automobile 8500 is charged with the use of a ground-based charging apparatus 8021 through a cable 8022. In charging, a given method such as CHAdeMO (registered trademark) or Combined Charging System may be referred to for a charging method, the standard of a connector, or the like as appropriate. The charging apparatus 8021 may be a charging station provided in a commerce facility or a power source in a house. For example, with the use of a plug-in technique, a power storage device included in the automobile 8500 can be charged by being supplied with electric power from outside. The charging can be performed by converting AC electric power into DC electric power through a converter such as an AC-DC converter.

Although not illustrated, the vehicle may include a power receiving device so as to be charged by being supplied with electric power from an above-ground power transmitting device in a contactless manner. In the case of the contactless power supply system, by fitting the power transmitting device in a road or an exterior wall, charging can be performed not only when the automobile stops but also when moves. In addition, the contactless power supply system may be utilized to perform transmission/reception between vehicles. Furthermore, a solar cell may be provided in the exterior of the automobile to charge the power storage device when the automobile stops or moves. To supply electric power in such a contactless manner, an electromagnetic induction method or a magnetic resonance method can be used.

According to one embodiment of the present invention, the power storage device can have improved cycle characteristics and reliability. Furthermore, according to one embodiment of the present invention, the power storage device itself can be made more compact and lightweight as a result of improved characteristics of the power storage device. The compact and lightweight power storage device contributes to a reduction in the weight of a vehicle, and thus increases the driving distance. Moreover, the power storage device included in the vehicle can be used as a power source for supplying electric power to products other than the vehicle. In that case, the use of a commercial power supply can be avoided at peak time of electric power demand.

This embodiment can be implemented in appropriate combination with any of the other embodiments.

### Embodiment 6

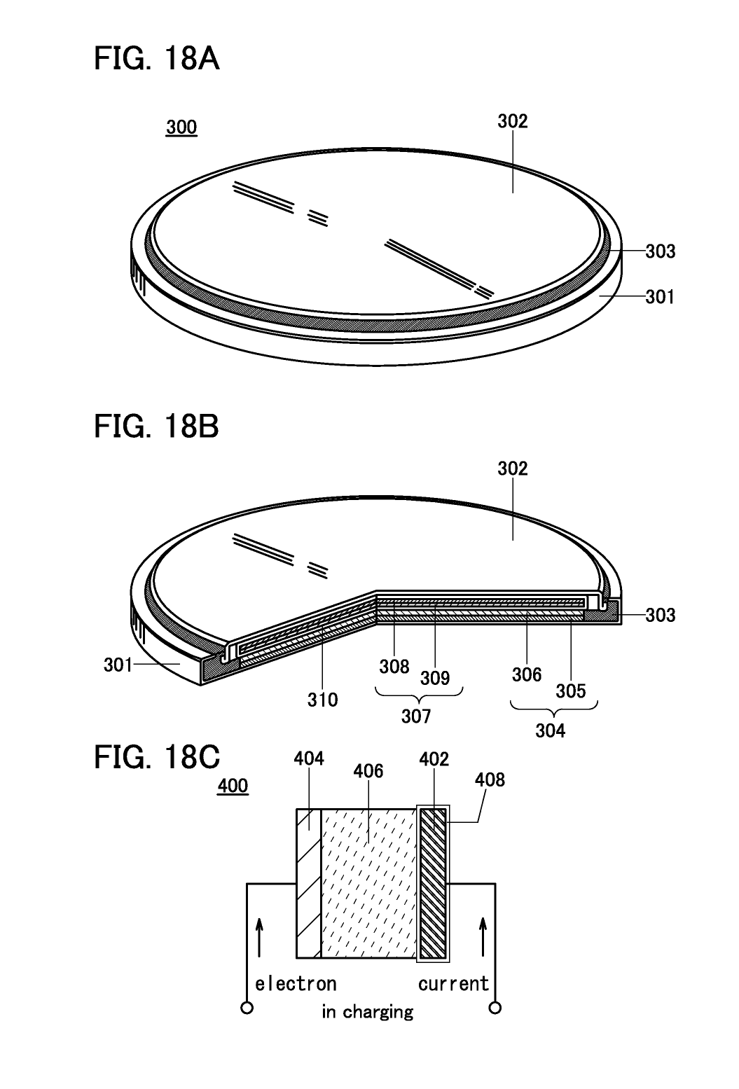

In this embodiment, an example of a coin-type power storage unit will be described with reference to FIG. 18A. When the coin-type power storage unit has flexibility, it can be easily attached to a curved surface. Furthermore, when the coin-type power storage unit is used in an electronic device at least part of which is flexible, the power storage unit can be bent as the electronic device is bent.

FIG. 18A is an external view of a coin-type (single-layer flat type) power storage unit, and FIG. 18B is a cross-sectional view thereof.

In a coin-type power storage unit 300, an exterior body 301 serving as a positive electrode terminal and an exterior body 302 serving as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. The positive electrode 304 can be manufactured in a manner similar to that of the positive electrode 101 shown in Embodiment 1.

A negative electrode 307 includes a negative electrode current collector 308 and a negative electrode active material layer 309 provided in contact with the negative electrode current collector 308. The negative electrode 307 is covered by an envelope 310. The envelope 310 and an electrolyte (not illustrated) are provided between the positive electrode active material layer 306 and the negative electrode active material layer 309.

The use of the power storage unit of one embodiment of the present invention can achieve a coin-type power storage unit whose function is less likely to be degraded.

The exterior bodies 301 and 302 can be formed using a metal having corrosion resistance to an electrolyte solution, such as nickel, aluminum, or titanium, an alloy of such a metal, or an alloy of such a metal and another metal (e.g., stainless steel). Alternatively, the exterior bodies 301 and 302 are preferably covered with nickel, aluminum, or the like in order to prevent corrosion caused by the electrolyte solution. The exterior body 301 and the exterior body 302 are electrically connected to the positive electrode 304 and the negative electrode 307, respectively.

The negative electrode 307, the positive electrode 304, and the envelope 310 are immersed in the electrolyte. Then, as illustrated in FIG. 18B, the exterior body 301, the positive electrode 304, the negative electrode 307 covered by the envelope 310, and the exterior body 302 are stacked in this order, and the exterior body 301 and the exterior body 302 are subjected to pressure bonding with the gasket 303 interposed therebetween. In such a manner, the coin-type power storage unit 300 having flexibility can be manufactured.

Here, a current flow in charging a battery is described with reference to FIG. 18C. When a battery using lithium is regarded as a closed circuit, lithium ions and current move in the same direction. Note that in the battery using lithium, an anode and a cathode change places in charge and discharge, and an oxidation reaction and a reduction reaction occur on the corresponding sides; hence, an electrode with a high redox potential is called a positive electrode and an electrode with a low redox potential is called a negative electrode. For this reason, in this specification, the positive electrode is referred to as a “positive electrode” and the negative electrode is referred to as a “negative electrode” in all the cases where charge is performed and discharge is performed. The use of the terms “anode” and “cathode” related to an oxidation reaction and a reduction reaction might cause confusion because the anode and the cathode change places at the time of charging and discharging. Thus, the terms “anode” and “cathode” are not used in this specification. If the term “anode” or “cathode” is used, it should be mentioned that the anode or the cathode is which of the one at the time of charging or the one at the time of discharging and corresponds to which of a positive electrode or a negative electrode.

A power storage unit 400 illustrated in FIG. 18C includes a positive electrode 402, a negative electrode 404, an electrolyte solution 406, and an envelope 408. The positive electrode 402 and the negative electrode 404 are connected to their respective terminals which are connected to a charger, whereby the power storage unit 400 is charged. As the charge of the power storage unit 400 proceeds, a potential difference between the positive electrode 402 and the negative electrode 404 increases. The positive direction in FIG. 18C is the direction in which a current flows from one terminal outside the power storage unit 400 to the positive electrode 402, flows from the positive electrode 402 to the negative electrode 404 in the power storage unit 400, and flows from the negative electrode 404 to the other terminal outside the power storage unit 400. In other words, a current flows in the direction of a charging current.

This embodiment can be implemented in appropriate combination with any of the other embodiments.

### Embodiment 7

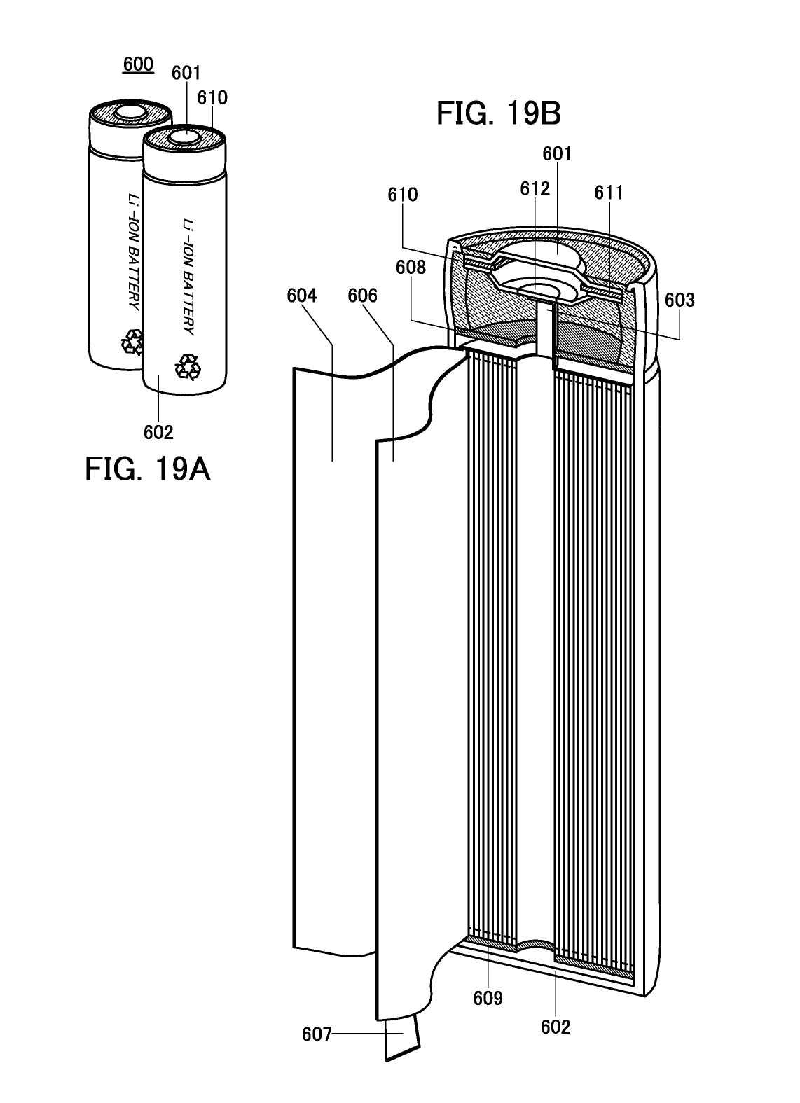

In this embodiment, an example of a cylindrical power storage unit will be described with reference to FIGS. 19A and 19B. When the cylindrical power storage unit has flexibility, it can be easily attached to a curved surface. Furthermore, when the flexible cylindrical power storage unit is used in an electronic device at least part of which is flexible, the power storage unit can be bent as the electronic device is bent.

As illustrated in FIG. 19A, a cylindrical power storage unit 600 includes a positive electrode cap (battery cap) 601 on the top surface and an exterior body 602 on the side and bottom surface. The positive electrode cap and the exterior body 602 are insulated from each other by a gasket (insulating gasket) 610.

FIG. 19B schematically illustrates a cross section of the cylindrical power storage unit. Inside the exterior body 602 having a hollow cylindrical shape, a battery element in which a strip-like positive electrode 604 and a strip-like negative electrode 606 covered by an envelope are wound is provided. Although not illustrated, the battery element is wound around a center pin. One end of the exterior body 602 is close and the other end thereof is open. The exterior body 602 can be formed using a metal having corrosion resistance to an electrolyte solution, such as nickel, aluminum, or titanium, an alloy of such a metal, or an alloy of such a metal and another metal (e.g., stainless steel). Alternatively, the exterior body 602 is preferably covered with nickel, aluminum, or the like in order to prevent corrosion caused by an electrolyte solution. Inside the exterior body 602, the battery element in which the positive electrode and the negative electrode covered by the envelope are wound is interposed between a pair of insulating plates 608 and 609 which face each other. Furthermore, a nonaqueous electrolyte solution (not illustrated) is injected inside the exterior body 602 provided with the battery element. The nonaqueous electrolyte solution can be similar to that in the above coin-type power storage unit.

The use of the power storage unit of one embodiment of the present invention can achieve a coin-type power storage unit whose function is less likely to be degraded.

A positive electrode terminal (positive electrode lead) 603 is connected to the positive electrode 604, and a negative electrode terminal (negative electrode lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the exterior body 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Note that barium titanate (BaTiO₃)-based semiconductor ceramic can be used for the PTC element.

This embodiment can be implemented in appropriate combination with any of the other embodiments.

### Embodiment 8

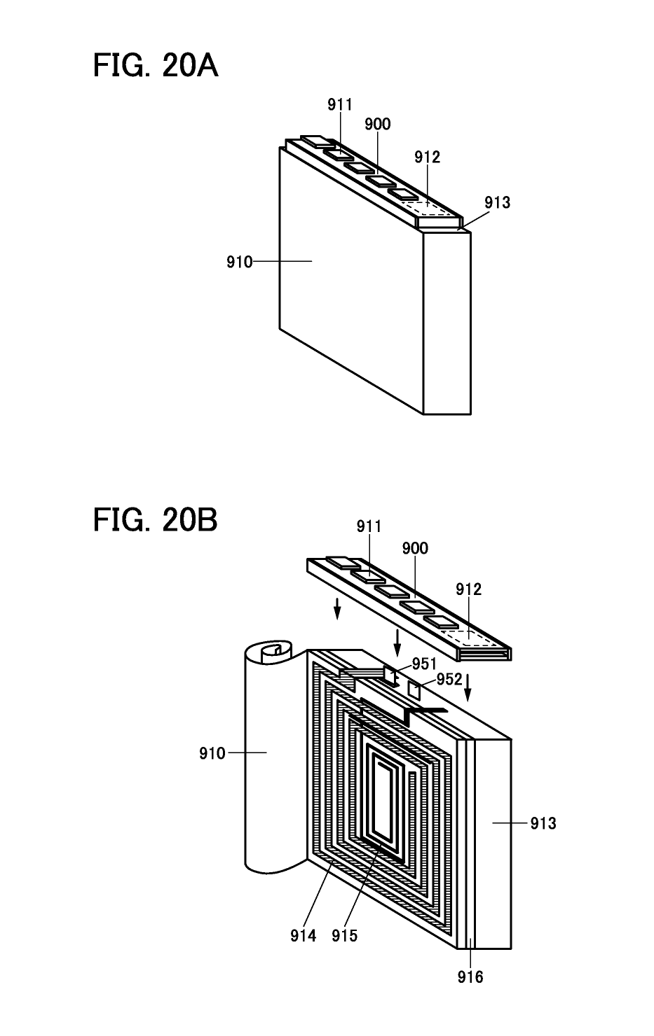

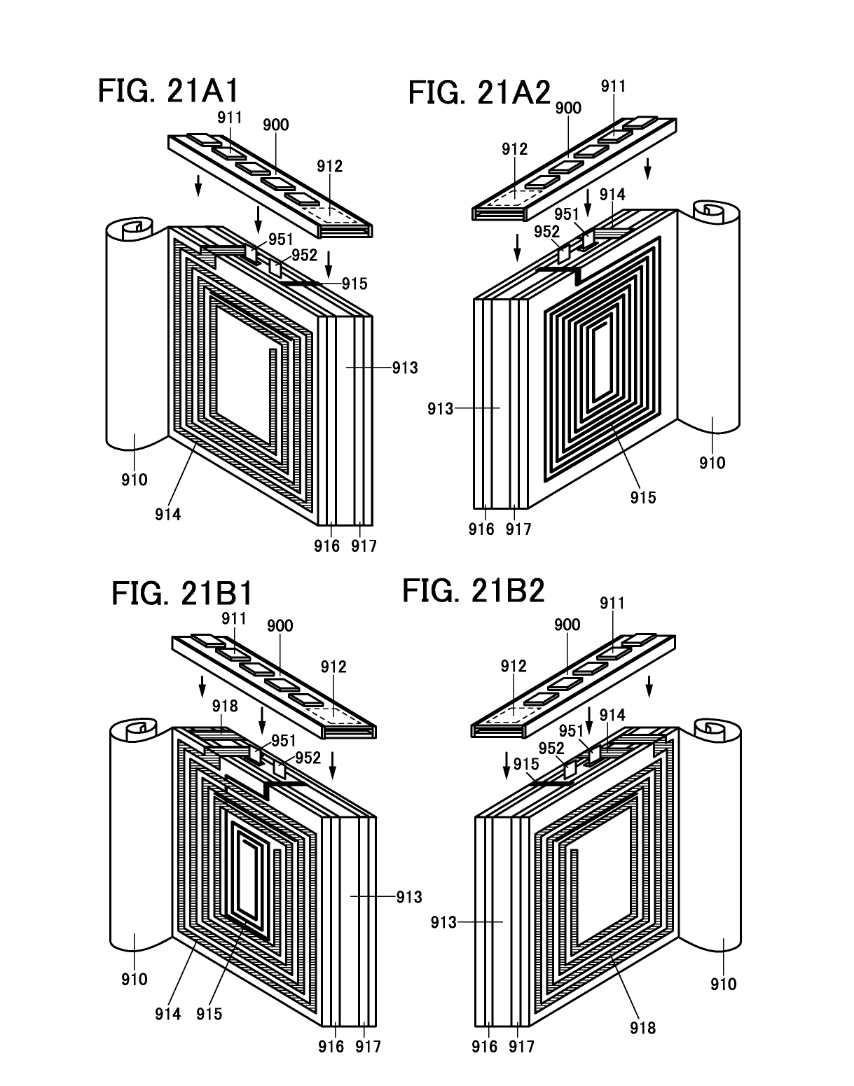

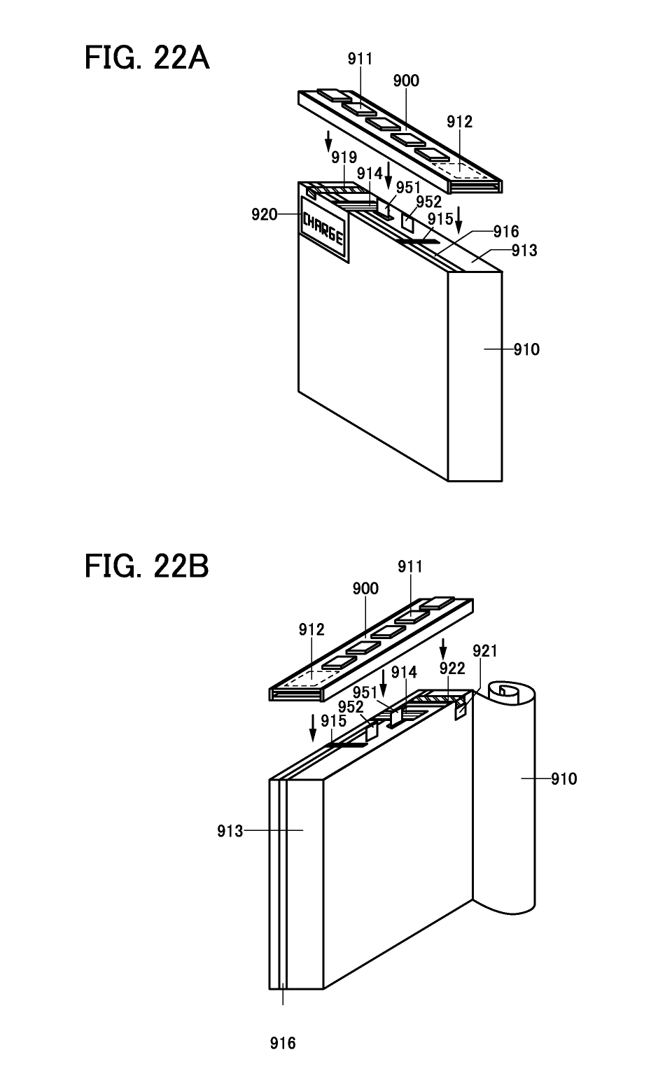

In this embodiment, examples of a structure of a power storage device (storage battery) will be described with reference to FIGS. 20A and 20B, FIGS. 21A1, 21A2, 21B1, and 21B2, FIGS. 22A and 22B, FIGS. 23A and 23B, and FIG. 24. When the power storage device has flexibility, it can be easily attached to a curved surface. Furthermore, when the flexible power storage device is used in an electronic device at least part of which is flexible, the power storage device can be bent as the electronic device is bent. Note that in this specification and the like, the power storage device includes at least the power storage unit of one embodiment of the present invention.

FIGS. 20A and 20B are external views of the power storage device. The power storage device in FIGS. 20A and 20B includes a circuit board 900 and a power storage unit 913. A label 910 is attached to the power storage unit 913. Furthermore, as illustrated in FIG. 20B, the power storage device includes a terminal 951 and a terminal 952, and includes an antenna 914 and an antenna 915 between the power storage unit 913 and the label 910.

The circuit board 900 includes terminals 911 and a circuit 912. The terminals 911 are connected to the terminals 951 and 952, the antennas 914 and 915, and the circuit 912. Note that a plurality of terminals 911 serving as a control signal input terminal, a power supply terminal, and the like may be provided.

The circuit 912 may be provided on the rear side of the circuit board 900. Note that each of the antennas 914 and 915 is not limited to having a coil shape and may have a linear shape or a plate shape. Alternatively, a planar antenna, an aperture antenna, a traveling-wave antenna, an EH antenna, a magnetic-field antenna, or a dielectric antenna may be used. Further alternatively, the antenna 914 or the antenna 915 may be a flat-plate conductor. The flat-plate conductor can serve as one of conductors for electric field coupling. That is, the antenna 914 or the antenna 915 can serve as one of two conductors of a capacitor. Thus, power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage device includes a layer 916 between the power storage unit 913 and the antennas 914 and 915. The layer 916 has a function of blocking an electromagnetic field from the power storage unit 913, for example. As the layer 916, for example, a magnetic body can be used.

Note that the structure of the power storage device is not limited to that illustrated in FIGS. 20A and 20B.

For example, as illustrated in FIGS. 21A1 and 21A2, two opposing surfaces of the power storage unit 913 in FIGS. 20A and 20B may be provided with their respective antennas. FIG. 21A1 is an external view showing one side of the opposing surfaces, and FIG. 21A2 is an external view showing the other side of the opposing surfaces. Note that for portions similar to those in FIGS. 20A and 20B, description on the power storage device shown in FIGS. 20A and 20B can be referred to as appropriate.

As illustrated in FIG. 21A1, the antenna 914 is provided on one of the opposing surfaces of the power storage unit 913 with the layer 916 provided therebetween, and as illustrated in FIG. 21A2, the antenna 915 is provided on the other of the opposing surfaces of the power storage unit 913 with a layer 917 provided therebetween. The layer 917 has a function of blocking an electromagnetic field from the power storage unit 913, for example. As the layer 917, for example, a magnetic body can be used.

With the above structure, both of the antennas 914 and 915 can be increased in size.

Alternatively, as illustrated in FIGS. 21B1 and 21B2, two opposing surfaces of the power storage unit 913 in FIGS. 20A and 20B may be provided with different types of antennas. FIG. 21B1 is an external view showing one side of the opposing surfaces, and FIG. 21B2 is an external view showing the other side of the opposing surfaces. Note that for portions similar to those in FIGS. 20A and 20B, description on the power storage device shown in FIGS. 20A and 20B can be referred to as appropriate.

As illustrated in FIG. 21B1, the antennas 914 and 915 are provided on one of the opposing surfaces of the power storage unit 913 with the layer 916 provided therebetween, and as illustrated in FIG. 21A2, an antenna 918 is provided on the other of the opposing surfaces of the power storage unit 913 with the layer 917 provided therebetween. The antenna 918 has a function of performing data communication with an external device, for example. An antenna with a shape that can be applied to the antennas 914 and 915, for example, can be used as the antenna 918. As a system for communication using the antenna 918 between the power storage device and another device, a response method which can be used between the power storage device and the another device, such as NFC, can be employed.

Alternatively, as illustrated in FIG. 22A, the power storage unit 913 in FIGS. 20A and 20B may be provided with a display device 920. The display device 920 is electrically connected to the terminal 911 via a terminal 919. It is possible that the label 910 is not provided in a portion where the display device 920 is provided. Note that for portions similar to those in FIGS. 20A and 20B, description on the power storage device shown in FIGS. 20A and 20B can be referred to as appropriate.

The display device 920 can display, for example, an image showing whether or not charging is being carried out, or an image showing the amount of stored power. As the display device 920, electronic paper, a liquid crystal display device, an electroluminescent (EL) display device, or the like can be used. For example, the power consumption of the display device 920 can be reduced when electronic paper is used.

Alternatively, as illustrated in FIG. 22B, the power storage unit 913 in FIGS. 20A and 20B may be provided with a sensor 921. The sensor 921 is electrically connected to the terminal 911 via a terminal 922. Note that the sensor 921 may be provided between the power storage unit 913 and the label 910. Note that for portions similar to those in FIGS. 20A and 20B, description on the power storage device shown in FIGS. 20A and 20B can be referred to as appropriate.

The sensor 921 has a function of measuring displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays. With the sensor 921, for example, data on an environment (e.g., temperature) where the power storage device is placed can be detected and stored in a memory inside the circuit 912.

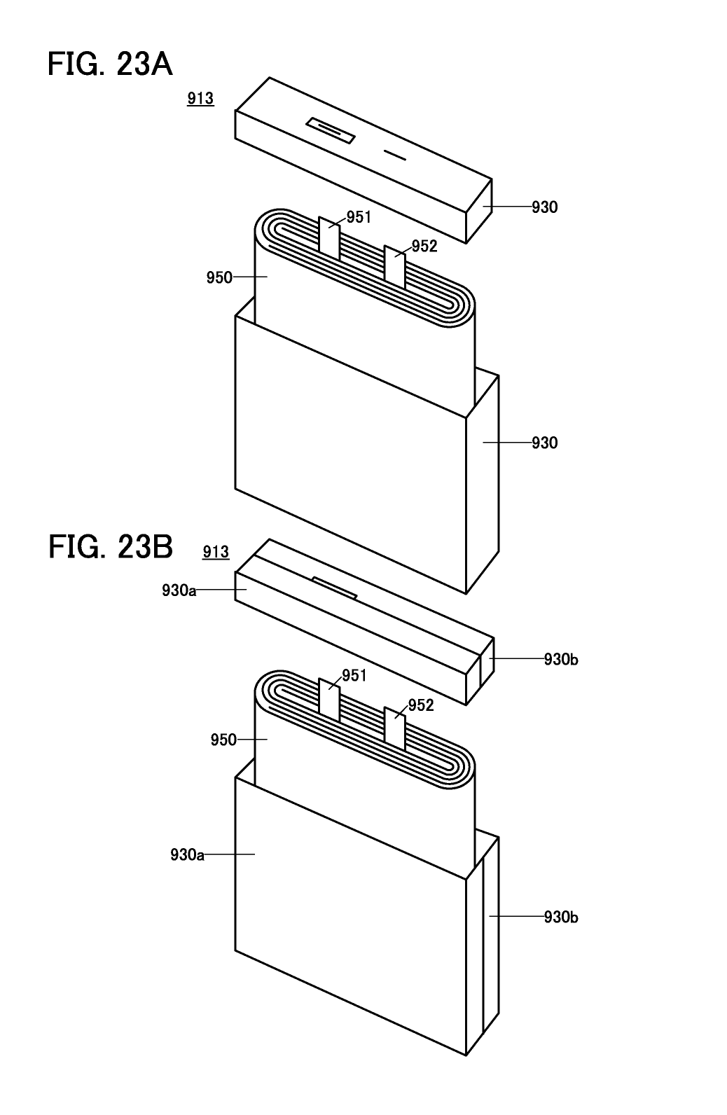

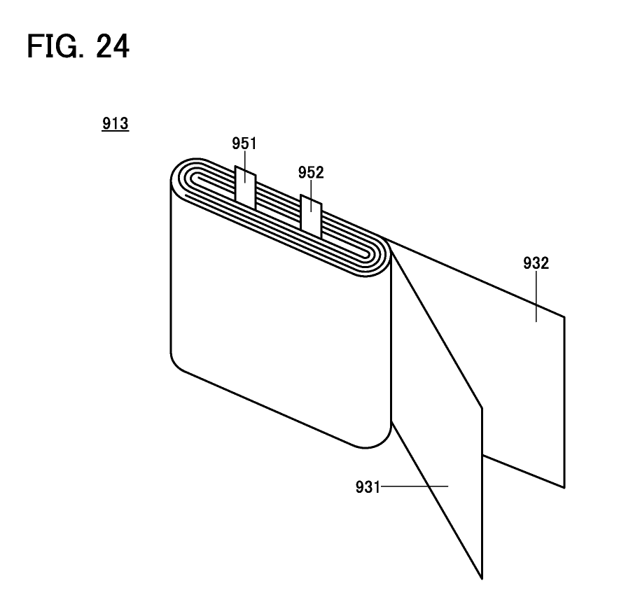

Examples of a structure of the power storage unit 913 will be described with reference to FIGS. 23A and 23B and FIG. 24.

The power storage unit 913 illustrated in FIG. 23A includes a wound body 950 provided with the terminals 951 and 952 inside a housing 930. The wound body 950 is soaked in an electrolyte solution inside the housing 930. The terminal 952 is in contact with the housing 930. An insulator or the like prevents contact between the terminal 951 and the housing 930. Note that FIG. 23A illustrates the housing 930 divided into two pieces for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 23B, the housing 930 in FIG. 23A may be formed using a plurality of materials. For example, in the power storage unit 913 in FIG. 23B, a housing 930a and a housing 930b are attached to each other and the wound body 950 is provided in a region surrounded by the housing 930a and the housing 930b.

For the housing 930a, an insulating material such as an organic resin can be used. In particular, when a material such as an organic resin is used for the side on which an antenna is formed, shielding of the electric field by the power storage unit 913 can be prevented. Note that an antenna such as the antennas 914 and 915 may be provided inside the housing 930a if the electric field is not completely shielded by the housing 930a. For the housing 930b, a metal material can be used, for example.

FIG. 24 illustrates a structure of the wound body 950. The wound body 950 includes a negative electrode 931 covered by an envelope and a positive electrode 932. The wound body 950 is obtained by winding a layered sheet in which the negative electrode 931 covered by the envelope overlaps with the positive electrode 932. Note that a plurality of layers each including the negative electrode 931 covered by the envelope and the positive electrode 932 may be stacked.

The negative electrode 931 covered by the envelope is connected to the terminal 911 in FIGS. 20A and 20B via one of the terminals 951 and 952. The positive electrode 932 is connected to the terminal 911 in FIGS. 20A and 20B via the other of the terminals 951 and 952.

This embodiment can be implemented in appropriate combination with any of the other embodiments.

### REFERENCE NUMERALS

100: power storage unit, 101: positive electrode, 102: negative electrode, 103: envelope, 104: positive electrode lead, 105: negative electrode lead, 106: electrolyte solution, 107: exterior body, 108: bonding portion, 113: film, 115: sealing layer, 118: bonding portion, 119: introduction port, 120: power storage unit, 150: power storage unit, 160: power storage unit, 170: power storage unit, 201: bonding die, 202: bonding die, 203: projections, 210: connection region, 220: bent portion, 300: power storage unit, 301: exterior body, 302: exterior body, 303: gasket, 304: positive electrode, 305: positive electrode current collector, 306: positive electrode active material layer, 307: negative electrode, 308: negative electrode current collector, 309: negative electrode active material layer, 310: envelope, 400: power storage unit, 402: positive electrode, 404: negative electrode, 406: electrolyte solution, 408: envelope, 600: power storage unit, 601: positive electrode cap, 602: exterior body, 603: positive electrode terminal, 604: positive electrode, 606: negative electrode, 607: negative electrode terminal, 608: insulating plate, 609: insulating plate, 611: PTC element, 612: safety valve mechanism, 900: circuit board, 910: label, 911: terminal, 912: circuit, 913: power storage unit, 914: antenna, 915: antenna, 916: layer, 917: layer, 918: antenna, 919: terminal, 920: display device, 921: sensor, 922: terminal, 930: housing, 931: negative electrode, 932: positive electrode, 950: wound body, 951: terminal, 952: terminal, 7100: portable display device, 7101: housing, 7102: display portion, 7103: operation button, 7104: power storage device, 7200: portable information terminal, 7201: housing, 7202: display portion, 7203: band, 7204: buckle, 7205: operation button, 7206: input output terminal, 7207: icon, 7300: display device, 7304: display portion, 7400: mobile phone, 7401: housing, 7402: display portion, 7403: operation button, 7404: external connection port, 7405: speaker, 7406: microphone, 7407: power storage device, 8000: display device, 8001: housing, 8002: display portion, 8003: speaker portion, 8004: power storage device, 8021: charging apparatus, 8022: cable, 8100: lighting device, 8101: housing, 8102: light source, 8103: power storage device, 8104: ceiling, 8105: wall, 8106: floor, 8107: window, 8200: indoor unit, 8201: housing, 8202: air outlet, 8203: power storage device, 8204: outdoor unit, 8300: electric refrigerator-freezer, 8301: housing, 8302: door for refrigerator, 8303: door for freezer, 8304: power storage device, 8400: automobile, 8401: headlight, 8500: automobile, 9600: tablet terminal, 9625: switch, 9626: switch, 9627: power switch, 9628: operation switch, 9629: fastener, 9630: housing, 9631: display portion, 9633: solar cell, 9634: charge and discharge control circuit, 9635: power storage device, 9636: DC-DC converter, 9637: converter, 9638: operation key, 9639: button, 9640: movable portion, 101a: positive electrode current collector, 101b: positive electrode active material layer, 102a: negative electrode current collector, 102b: negative electrode active material layer, 113A: film, 113B: film, 930a: housing, 930b: housing, 9630a: housing, 9630b: housing, 9631a: display portion, 9631b: display portion, 9632a: region, 9632b: region.

This application is based on Japanese Patent Application serial no. 2013-236696 filed with Japan Patent Office on Nov. 15, 2013, the entire contents of which are hereby incorporated by reference.

1. A power storage unit comprising:
a positive electrode;
a negative electrode;
an envelope;
an exterior body enveloping the positive electrode, the negative electrode, and the envelope;
a first wiring electrically connected to the positive electrode and extending from inside of the exterior body; and
a second wiring electrically connected to the negative electrode and extending from inside of the exterior body,
wherein at least one of the positive electrode and the negative electrode is in the envelope,
wherein the envelope comprises an insulating material, and
wherein each of the exterior body, the positive electrode, the negative electrode, and the envelope has flexibility.

2. The power storage unit according to claim 1, further comprising an active material in the envelope.

3. The power storage unit according to claim 1,
wherein the number of the positive electrodes is two or more, and
wherein the number of the negative electrodes is two or more.

4. The power storage unit according to claim 1, wherein the insulating material is a porous insulator.

5. The power storage unit according to claim 1, wherein the insulating material is polypropylene.

6. The power storage unit according to claim 1, wherein the insulating material is polyethylene.

7. The power storage unit according to claim 1, wherein at least one of the positive electrode and the negative electrode comprises a bent portion.

8. An electronic device comprising the power storage unit according to claim 1.

9. A power storage unit comprising:
a positive electrode in a first envelope;
a negative electrode in a second envelope;
an exterior body enveloping the positive electrode, the negative electrode, the first envelope, and the second envelope;
a first wiring electrically connected to the positive electrode and extending from inside of the exterior body; and
a second wiring electrically connected to the negative electrode and extending from inside of the exterior body,
wherein the first envelope comprises a first insulating material,
wherein the second envelope comprises a second insulating material, and
wherein each of the exterior body, the positive electrode, the negative electrode, the first envelope, and the second envelope has flexibility.

10. The power storage unit according to claim 9, wherein the first envelope is in contact with the second envelope.

11. The power storage unit according to claim 9, wherein the first insulating material is different from the second insulating material.

12. The power storage unit according to claim 9, further comprising a first active material in the first envelope and a second active material in the second envelope.

13. The power storage unit according to claim 9,
wherein the number of the positive electrodes is two or more, and
wherein the number of the negative electrodes is two or more.

14. The power storage unit according to claim 9, wherein at least one of the first insulating material and the second insulating material is a porous insulator.

15. The power storage unit according to claim 9, wherein at least one of the first insulating material and the second insulating material is polypropylene.

16. The power storage unit according to claim 9, wherein at least one of the first insulating material and the second insulating material is polyethylene.

17. An electronic device comprising the power storage unit according to claim 9.
